(19) United States
(12) Patent Application Publication
(10) Pub. No.: US 2014/0093712 A1
(43) Pub. Date: Apr. 3, 2014

(54) Polycarbonate ABS Composites with Improved Electromagnetic Shielding Effectiveness

(71) Applicant: SABIC INNOVATIVE PLASTICS IP B.V., Bergen op Zoom (NL)

(72) Inventors: Wu Tong, Shanghai (CN); An Yuxian, Shanghai (CN)

(73) Assignee: SABIC INNOVATIVE PLASTICS IP B.V., Bergen op Zoom (NL)

(21) Appl. No.: 13/631,180

(22) Filed: Sep. 28, 2012

(51) Int. Cl. C08L 47/00; C08K 5/09; C08K 5/52; C08K 3/38

(52) U.S. Cl. 428/220; 524/440; 524/127; 524/405; 524/291; 524/153

(57) ABSTRACT

Disclosed herein are methods and compositions of blended polycarbonate resins with improved electromagnetic shielding. The resulting compositions, comprising high strength stainless steel, can be used in the manufacture of articles while still retaining the advantageous physical properties of blended polycarbonate compositions. This abstract is intended as a scanning tool for purposes of searching in the particular art and is not intended to be limiting of the present invention.

### FIELD OF INVENTION

The present invention relates to electromagnetic wave shielding thermoplastic resin compositions having improved electromagnetic shielding properties comprising polycarbonate/acrylonitrile-butadiene-styrene blended compositions and high strength stainless steel fibers.

### BACKGROUND

Increasingly there is a strong market demand for engineering thermoplastic materials having excellent electromagnetic shielding effectiveness while exposing to tanglesome electromagnetic environment. Such demand exists particularly in the automotive industry and business equipment housing industry where engineering thermoplastics are being increasingly demanded for better electromagnetic shielding effectiveness, especially, it is very important for maintaining the desired EMI shielding performance under thinner part application, due to the trends towards thinner wall part and multiple functional designs.

However, the presently available plastic materials suffer from the disadvantage of being transparent or permeable to electromagnetic interference commonly known as, and referred to, as EMI. This drawback in available plastic materials is a matter of considerable concern in view of the susceptibility of electronic equipment to the adverse effects of EMI emission by the growing number of consumer products which produce such EMI signals and to the increasing regulatory controls exercised over such electromagnetic pollution.

Currently, the major approach to solving plastic material shielding problems is through the application of metallic surface coatings to the molded plastic. Among such approaches are the use of vacuum deposition, metal foil linings, metal-filled spray coatings, zinc flame-spray and electric arc discharge. Each of these procedures is accompanied by one or more drawbacks with respect to cost, adhesion, scratch resistance, environmental resistance, the length of time required for application and the difficulties in adequately protecting many of the diverse geometrical forms in which the molded plastic must be provided.

More recently, attempts have been made to resolve the problem of EMI by formulation of composite plastic materials based upon the use of various fillers in thermoplastic matrices. Among the conductive fillers which have been employed for this purpose are carbon black, carbon fibers, silver coated glass beads and metallized glass fibers. However, these materials are subject to the disadvantages of being brittle to the extent that they break up into shorter lengths in processing. The shorter length fibers and particles require higher loadings or filler concentrations leading to embrittlement of the plastic matrix and higher costs which render them commercially unacceptable. Hence, none of the composite plastic products developed heretofore have proven completely satisfactory.

It has been well known that electromagnetic shielding effectiveness of materials has strong dependence on thickness with the same loading of the conductive filler. Typically, higher loadings of the conductive filler are required to obtain the desired shielding performance under thinner wall application. But the higher loading of the conductive fillers will lead to decrease in the melt strength of the strands and the blockage of extruder die, which will result in significant processing challenges. Furthermore, poorer surface quality and more expensive cost will be incurred due to the presence of higher loading conductive fibers. Consequently, the amount of conductive fiber is strictly limited in order to maintain the balance of appearance quality, cost performance and process capacity, and it is a great challenge to meet the desired EMI shielding performance when producing thinner wall articles.

Thus, there remains a strong need for improved thermoplastic materials that can provide better electromagnetic shielding effectiveness under same or lower loadings of the conductive filler, especially for the articles requiring a wall part with less than or equal to about 1.5 mm wall thickness. Accordingly, it would be beneficial to provide electromagnetic wave shielding thermoplastic resin compositions that have improved electromagnetic shielding properties.

### SUMMARY OF THE INVENTION

In one aspect, the invention relates to electromagnetic wave shielding thermoplastic resin compositions having improved electromagnetic shielding properties comprising polycarbonate/acrylonitrile-butadiene-styrene blended compositions and high strength stainless steel fibers. The disclosed compositions exhibit superior electromagnetic wave shielding performance while retaining suitable strength properties, heat deflection temperature, and flexural properties. In various aspects, the disclosed thermoplastic resin compositions have application to uses and articles that must have thin walled design.

In one aspect, described herein are electromagnetic wave shielding thermoplastic resin compositions, comprising: a) a continuous thermoplastic polymer phase comprising from about 30 wt % to about 75 wt % of a blend of a polycarbonate and an acrylonitrile butadiene styrene polymer; and b) a dispersed phase comprising a plurality stainless steel fibers and glass fibers dispersed within the continuous thermoplastic polymer phase; i) wherein the high strength stainless steel fibers are present in an amount from about 5 wt % to about 30 wt %; wherein the high strength stainless steel fiber has a single fiber strength of greater than or equal to about 20 cN and an elongation of greater than or equal to about 2%; and ii) wherein the glass fibers are present in an amount from about 0 wt % to about 30 wt %; wherein the composition exhibits electromagnetic wave shielding performance at least about 10% greater when determined on a 1.5 mm thick sample compared to that of a reference composition consisting of substantially the same proportions of the blend of a polycarbonate and an acrylonitrile butadiene styrene polymer, the same glass fiber, and a standard strength steel fiber instead of a high strength steel fiber; and wherein the standard strength steel fiber has a single fiber strength of less than or equal to about 19 cN and an elongation of less than or equal to about 1.5%.

In a further aspect, described herein are electromagnetic wave shielding thermoplastic resin compositions, comprising: a) a continuous thermoplastic polymer phase comprising from about 30 wt % to about 75 wt % of a blend of a polycarbonate and an acrylonitrile butadiene styrene polymer; and b) a dispersed phase comprising a plurality stainless steel fibers and glass fibers dispersed within the continuous thermoplastic polymer phase; i) wherein the high strength stainless steel fibers are present in an amount of about 20 wt %; wherein the high strength stainless steel fiber has a single fiber strength of greater than or equal to about 20 cN and an elongation of greater than or equal to about 2%; and ii) wherein the glass fibers are present in an amount from about 0 wt % to about 30 wt %; wherein the composition exhibits electromagnetic wave shielding performance of at least about 60 dB when determined on a 1.2 mm thick sample.

In a further aspect, the invention pertains to plastic articles comprising the disclosed electromagnetic wave shielding thermoplastic resin compositions.

In a further aspect, the invention pertains to electrical and electronic devices comprising the disclosed electromagnetic wave shielding thermoplastic resin compositions.

In various aspects, the invention pertains to a process for forming articles comprising a electromagnetic wave shielding thermoplastic resin composition comprising the steps of: feeding a blend of a polycarbonate and an acrylonitrile butadiene styrene polymer, high strength stainless steel fibers, and glass fibers into an in-line compounding machine; compounding blend of a polycarbonate and an acrylonitrile butadiene styrene polymer, high strength stainless steel fibers to form an electromagnetic wave shielding thermoplastic material; passing the electromagnetic wave shielding thermoplastic material to an injection plunger of the in-line compounding machine; and injecting the electromagnetic wave shielding thermoplastic material into a mold using either an injection molding process or an injection-compression molding process; wherein the article exhibits electromagnetic wave shielding performance of at least about 60 dB when determined on a 1.2 mm thick sample.

In various aspects, the invention pertains to methods of preparing a composition, comprising blending: a) from about 30 wt % to about 75 wt % of a blend of a polycarbonate and an acrylonitrile butadiene styrene polymer, b) from about 5 wt % to about 30 wt % high strength stainless steel fibers; and c) from about 0 wt % to about 30 wt % glass fibers; wherein the high strength stainless steel fibers have a single fiber strength of greater than or equal to about 20 cN and an elongation of greater than or equal to about 2%; and wherein the composition exhibits electromagnetic wave shielding performance at least about 60 dB when determined on a 1.2 mm thick sample.

In an even further aspect, described herein are processes to improve the electromagnetic shielding of blended polycarbonate compositions comprising the addition of an effective amount of high strength stainless steel fibers, wherein the high strength stainless steel fibers have a single fiber strength of greater than or equal to about 20 cN and an elongation of greater than or equal to about 2%.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. Although any methods and materials similar or equivalent to those described herein can be used in the practice or testing of the present invention, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

All publications mentioned herein are incorporated herein by reference to disclose and describe the methods and/or materials in connection with which the publications are cited.

### DEFINITIONS

It is also to be understood that the terminology used herein is for the purpose of describing particular aspects only and is not intended to be limiting. As used in the specification and in the claims, the term “comprising” may include the embodiments “consisting of” and “consisting essentially of” Unless defined otherwise, all technical and scientific terms used herein have the same meaning as commonly understood by one of ordinary skill in the art to which this invention belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a functional group,” “an alkyl,” or “a residue” includes mixtures of two or more such functional groups, alkyls, or residues, and the like. Furthermore, for example, reference to a filler includes mixtures of fillers.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about,” “approximate,” and “at or about” mean that the amount or value in question can be the exact value designated or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or can not occur, and that the description includes instances where said event or circumstance occurs and instances where it does not. For example, the phrase “optionally substituted alkyl” means that the alkyl group can or can not be substituted and that the description includes both substituted and unsubstituted alkyl groups.

As used herein, the term “effective amount” refers to an amount that is sufficient to achieve the desired modification of a physical property of the composition or material. For example, an “effective amount” of a polymer additive refers to an amount that is sufficient to achieve the desired improvement in the property modulated by the polymer additive, e.g. oxidation stability, under applicable test conditions and without adversely affecting other specified properties. The specific level in terms of wt % in a composition required as an effective amount will depend upon a variety of factors including the amount and type of hydrolytic stabilizer, amount and type of polycarbonate polymer compositions, amount and type of impact modifier compositions, and end use of the article made using the composition.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific aspect or combination of aspects of the methods of the invention.

References in the specification and concluding claims to parts by weight, of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included. For example if a particular element or component in a composition or article is said to have 8% weight, it is understood that this percentage is relation to a total compositional percentage of 100%.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group. Unless defined otherwise, technical and scientific terms used herein have the same meaning as is commonly understood by one of skill in the art to which this invention belongs.

The terms “first,” “second,” “first part,” “second part,” and the like, where used herein, do not denote any order, quantity, or importance, and are used to distinguish one element from another, unless specifically stated otherwise.

The term “alkyl group” as used herein is a branched or unbranched saturated hydrocarbon group of 1 to 24 carbon atoms, such as methyl, ethyl, n-propyl, isopropyl, n-butyl, isobutyl, t-butyl, pentyl, hexyl, heptyl, octyl, decyl, tetradecyl, hexadecyl, eicosyl, tetracosyl and the like. A “lower alkyl” group is an alkyl group containing from one to six carbon atoms.

The term “aryl group” as used herein is any carbon-based aromatic group including, but not limited to, benzene, naphthalene, etc. The term “aromatic” also includes “heteroaryl group,” which is defined as an aromatic group that has at least one heteroatom incorporated within the ring of the aromatic group. Examples of heteroatoms include, but are not limited to, nitrogen, oxygen, sulfur, and phosphorus. The aryl group can be substituted or unsubstituted. The aryl group can be substituted with one or more groups including, but not limited to, alkyl, alkynyl, alkenyl, aryl, halide, nitro, amino, ester, ketone, aldehyde, hydroxy, carboxylic acid, or alkoxy.

The term “aralkyl” as used herein is an aryl group having an alkyl, alkynyl, or alkenyl group as defined above attached to the aromatic group. An example of an aralkyl group is a benzyl group.

The term “carbonate group” as used herein is represented by the formula —OC(O)OR, where R can be hydrogen, an alkyl, alkenyl, alkynyl, aryl, aralkyl, cycloalkyl, halogenated alkyl, or heterocycloalkyl group described above.

As used herein, the terms “number average molecular weight” or “Mn” can be used interchangeably, and refer to the statistical average molecular weight of all the polymer chains in the sample and is defined by the formula:

$$Mn = \frac{\sum {N}_{i} {M}_{i}}{\sum {N}_{i}} ,$$

where Mᵢ is the molecular weight of a chain and Nᵢ is the number of chains of that molecular weight. Mn can be determined for polymers, such as polycarbonate polymers or polycarbonate-PMMA copolymers, by methods well known to a person having ordinary skill in the art.

As used herein, the terms “weight average molecular weight” or “Mw” can be used interchangeably, and are defined by the formula:

$$Mw = \frac{\sum {N}_{i} {M}_{i}^{2}}{\sum {N}_{i} {M}_{i}} ,$$

where Mᵢ is the molecular weight of a chain and Nᵢ is the number of chains of that molecular weight. Compared to Mn, Mw takes into account the molecular weight of a given chain in determining contributions to the molecular weight average. Thus, the greater the molecular weight of a given chain, the more the chain contributes to the Mw. Mw can be determined for polymers, such as polycarbonate polymers or polycarbonate-PMMA copolymers, by methods well known to a person having ordinary skill in the art.

As used herein, the terms “polydispersity index” or “PDI” can be used interchangeably, and are defined by the formula:

PDI=Mw/Mn.

The PDI has a value equal to or greater than 1, but as the polymer chains approach uniform chain length, the PDI approaches unity.

The term “organic residue” defines a carbon containing residue, i.e., a residue comprising at least one carbon atom, and includes but is not limited to the carbon-containing groups, residues, or radicals defined hereinabove. Organic residues can contain various heteroatoms, or be bonded to another molecule through a heteroatom, including oxygen, nitrogen, sulfur, phosphorus, or the like. Examples of organic residues include but are not limited alkyl or substituted alkyls, alkoxy or substituted alkoxy, mono or di-substituted amino, amide groups, etc. Organic residues can preferably comprise 1 to 18 carbon atoms, 1 to 15, carbon atoms, 1 to 12 carbon atoms, 1 to 8 carbon atoms, 1 to 6 carbon atoms, or 1 to 4 carbon atoms. In a further aspect, an organic residue can comprise 2 to 18 carbon atoms, 2 to 15, carbon atoms, 2 to 12 carbon atoms, 2 to 8 carbon atoms, 2 to 4 carbon atoms, or 2 to 4 carbon atoms.

A very close synonym of the term “residue” is the term “radical,” which as used in the specification and concluding claims, refers to a fragment, group, or substructure of a molecule described herein, regardless of how the molecule is prepared. For example, a 2,4-thiazolidinedione radical in a particular compound has the structure:

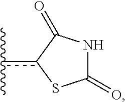

regardless of whether thiazolidinedione is used to prepare the compound. In some embodiments the radical (for example an alkyl) can be further modified (i.e., substituted alkyl) by having bonded thereto one or more “substituent radicals.” The number of atoms in a given radical is not critical to the present invention unless it is indicated to the contrary elsewhere herein.

“Organic radicals,” as the term is defined and used herein, contain one or more carbon atoms. An organic radical can have, for example, 1-26 carbon atoms, 1-18 carbon atoms, 1-12 carbon atoms, 1-8 carbon atoms, 1-6 carbon atoms, or 1-4 carbon atoms. In a further aspect, an organic radical can have 2-26 carbon atoms, 2-18 carbon atoms, 2-12 carbon atoms, 2-8 carbon atoms, 2-6 carbon atoms, or 2-4 carbon atoms. Organic radicals often have hydrogen bound to at least some of the carbon atoms of the organic radical. One example, of an organic radical that comprises no inorganic atoms is a 5, 6, 7, 8-tetrahydro-2-naphthyl radical. In some embodiments, an organic radical can contain 1-10 inorganic heteroatoms bound thereto or therein, including halogens, oxygen, sulfur, nitrogen, phosphorus, and the like. Examples of organic radicals include but are not limited to an alkyl, substituted alkyl, cycloalkyl, substituted cycloalkyl, mono-substituted amino, di-substituted amino, acyloxy, cyano, carboxy, carboalkoxy, alkylcarboxamide, substituted alkylcarboxamide, dialkylcarboxamide, substituted dialkylcarboxamide, alkylsulfonyl, alkylsulfinyl, thioalkyl, thiohaloalkyl, alkoxy, substituted alkoxy, haloalkyl, haloalkoxy, aryl, substituted aryl, heteroaryl, heterocyclic, or substituted heterocyclic radicals, wherein the terms are defined elsewhere herein. A few non-limiting examples of organic radicals that include heteroatoms include alkoxy radicals, trifluoromethoxy radicals, acetoxy radicals, dimethylamino radicals and the like.

The terms “BisA” or “bisphenol A,” which can be used interchangeably, as used herein refers to a compound having a structure represented by the formula:

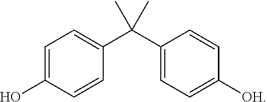 [SMILES: CC(C)(c1ccc(O)cc1)c1ccc(O)cc1]

BisAP can also be referred to by the name 4,4′-(propane-2,2-diyl)diphenol; p,p′-isopropylidenebisphenol; or 2,2-bis(4-hydroxyphenyl)propane. BisA has the CAS #80-05-7.

As used herein, the term “polycarbonate” refers to a polymer comprising the same or different carbonate units, or a copolymer that comprises the same or different carbonate units, as well as one or more units other than carbonate (i.e. copolycarbonate). The term polycarbonate can be further defined as compositions have repeating structural units of the formula (1):

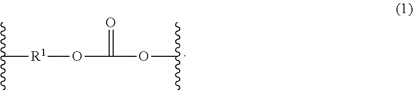

The term “miscible” refers to blends that are a mixture on a molecular level wherein intimate polymer-polymer interaction is achieved.

The terms “polycarbonate” or “polycarbonates” as used herein includes copolycarbonates, homopolycarbonates and (co)polyester carbonates.

The terms “residues” and “structural units”, used in reference to the constituents of the polymers, are synonymous throughout the specification.

As used herein, the term “ABS” or “acrylonitrile-butadiene-styrene copolymer” refers to an acrylonitrile-butadiene-styrene polymer which can be an acrylonitrile-butadiene-styrene terpolymer or a blend of styrene-butadiene rubber and styrene-acrylonitrile copolymer.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### Electromagnetic Wave Shielding Thermoplastic Resin Compositions

As briefly described above, the present invention relates to electromagnetic wave shielding thermoplastic resin compositions having improved electromagnetic shielding properties comprising polycarbonate/acrylonitrile-butadiene-styrene blended compositions and high strength stainless steel fibers. The disclosed compositions exhibit superior electromagnetic wave shielding performance while retaining suitable strength properties, heat deflection temperature, and flexural properties. In various aspects, the disclosed thermoplastic resin compositions have application to uses and articles that must have thin walled design.

In one aspect, the invention pertains to electromagnetic wave shielding thermoplastic resin compositions, comprising a) a continuous thermoplastic polymer phase comprising from about 30 wt % to about 75 wt % of a blend of a polycarbonate and an acrylonitrile butadiene styrene polymer; and b) a dispersed phase comprising a plurality stainless steel fibers and glass fibers dispersed within the continuous thermoplastic polymer phase; i) wherein the high strength stainless steel fibers are present in an amount from about 5 wt % to about 30 wt %; wherein the high strength stainless steel fiber has a single fiber strength of greater than or equal to about 20 cN and an elongation of greater than or equal to about 2%; and ii) wherein the glass fibers are present in an amount from about 0 wt % to about 30 wt %; wherein the composition exhibits electromagnetic wave shielding performance at least about 10% greater when determined on a 1.5 mm thick sample compared to that of a reference composition consisting of substantially the same proportions of the blend of a polycarbonate and an acrylonitrile butadiene styrene polymer, the same glass fiber, and a standard strength steel fiber instead of a high strength steel fiber; and wherein the standard strength steel fiber has a single fiber strength of less than or equal to about 19 cN and an elongation of less than or equal to about 1.5%.

In a further aspect, the invention pertains to electromagnetic wave shielding thermoplastic resin compositions, comprising a) a continuous thermoplastic polymer phase comprising from about 30 wt % to about 75 wt % of a blend of a polycarbonate and an acrylonitrile butadiene styrene polymer; and b) a dispersed phase comprising a plurality stainless steel fibers and glass fibers dispersed within the continuous thermoplastic polymer phase; i) wherein the high strength stainless steel fibers are present in an amount of about 20 wt %; wherein the high strength stainless steel fiber has a single fiber strength of greater than or equal to about 20 cN and an elongation of greater than or equal to about 2%; and ii) wherein the glass fibers are present in an amount from about 0 wt % to about 30 wt %; wherein the composition exhibits electromagnetic wave shielding performance at least about 18% greater when determined on a 1.5 mm thick sample compared to that of a reference composition consisting of substantially the same proportions of the blend of a polycarbonate and an acrylonitrile butadiene styrene polymer, the same glass fiber, and a standard strength steel fiber instead of a high strength steel fiber; and wherein the standard strength steel fiber has a single fiber strength of less than or equal to about 19 cN and an elongation of less than or equal to about 1.5%.

In a further aspect, the invention pertains to electromagnetic wave shielding thermoplastic resin compositions, comprising a) a continuous thermoplastic polymer phase comprising from about 30 wt % to about 75 wt % of a blend of a polycarbonate and an acrylonitrile butadiene styrene polymer; and b) a dispersed phase comprising a plurality stainless steel fibers and glass fibers dispersed within the continuous thermoplastic polymer phase; i) wherein the high strength stainless steel fibers are present in an amount of about 15 wt %; wherein the high strength stainless steel fiber has a single fiber strength of greater than or equal to about 20 cN and an elongation of greater than or equal to about 2%; and ii) wherein the glass fibers are present in an amount from about 0 wt % to about 30 wt %; wherein the composition exhibits electromagnetic wave shielding performance at least about 18% greater when determined on a 1.5 mm thick sample compared to that of a reference composition consisting of substantially the same proportions of the blend of a polycarbonate and an acrylonitrile butadiene styrene polymer, the same glass fiber, and a standard strength steel fiber instead of a high strength steel fiber; and wherein the standard strength steel fiber has a single fiber strength of less than or equal to about 19 cN and an elongation of less than or equal to about 1.5%.

In a further aspect, the invention pertains to electromagnetic wave shielding thermoplastic resin compositions, comprising a) a continuous thermoplastic polymer phase comprising from about 30 wt % to about 75 wt % of a blend of a polycarbonate and an acrylonitrile butadiene styrene polymer; and b) a dispersed phase comprising a plurality stainless steel fibers and glass fibers dispersed within the continuous thermoplastic polymer phase; i) wherein the high strength stainless steel fibers are present in an amount of about 20 wt %; wherein the high strength stainless steel fiber has a single fiber strength of greater than or equal to about 20 cN and an elongation of greater than or equal to about 2%; and ii) wherein the glass fibers are present in an amount from about 0 wt % to about 30 wt %; wherein the composition exhibits electromagnetic wave shielding performance of at least about 57 dB when determined on a 1.5 mm thick sample.

In a further aspect, the invention pertains to electromagnetic wave shielding thermoplastic resin compositions, comprising a) a continuous thermoplastic polymer phase comprising from about 30 wt % to about 75 wt % of a blend of a polycarbonate and an acrylonitrile butadiene styrene polymer; and b) a dispersed phase comprising a plurality stainless steel fibers and glass fibers dispersed within the continuous thermoplastic polymer phase; i) wherein the high strength stainless steel fibers are present in an amount of about 15 wt %; wherein the high strength stainless steel fiber has a single fiber strength of greater than or equal to about 20 cN and an elongation of greater than or equal to about 2%; and ii) wherein the glass fibers are present in an amount from about 0 wt % to about 30 wt %; wherein the composition exhibits electromagnetic wave shielding performance of at least about 52 dB when determined on a 1.5 mm thick sample.

In a further aspect, the invention pertains to electromagnetic wave shielding thermoplastic resin compositions, comprising a) a continuous thermoplastic polymer phase comprising from about 30 wt % to about 75 wt % of a blend of a polycarbonate and an acrylonitrile butadiene styrene polymer; and b) a dispersed phase comprising a plurality stainless steel fibers and glass fibers dispersed within the continuous thermoplastic polymer phase; i) wherein the high strength stainless steel fibers are present in an amount of about 20 wt %; wherein the high strength stainless steel fiber has a single fiber strength of greater than or equal to about 20 cN and an elongation of greater than or equal to about 2%; and ii) wherein the glass fibers are present in an amount from about 0 wt % to about 30 wt %; wherein the composition exhibits electromagnetic wave shielding performance at least about 30% greater when determined on a 1.2 mm thick sample compared to that of a reference composition consisting of substantially the same proportions of the blend of a polycarbonate and an acrylonitrile butadiene styrene polymer, the same glass fiber, and a standard strength steel fiber instead of a high strength steel fiber; and wherein the standard strength steel fiber has a single fiber strength of less than or equal to about 19 cN and an elongation of less than or equal to about 1.5%.

In a further aspect, the invention pertains to electromagnetic wave shielding thermoplastic resin compositions, comprising a) a continuous thermoplastic polymer phase comprising from about 30 wt % to about 75 wt % of a blend of a polycarbonate and an acrylonitrile butadiene styrene polymer; and b) a dispersed phase comprising a plurality stainless steel fibers and glass fibers dispersed within the continuous thermoplastic polymer phase; i) wherein the high strength stainless steel fibers are present in an amount of about 15 wt %; wherein the high strength stainless steel fiber has a single fiber strength of greater than or equal to about 20 cN and an elongation of greater than or equal to about 2%; and ii) wherein the glass fibers are present in an amount from about 0 wt % to about 30 wt %; wherein the composition exhibits electromagnetic wave shielding performance at least about 42% greater when determined on a 1.2 mm thick sample compared to that of a reference composition consisting of substantially the same proportions of the blend of a polycarbonate and an acrylonitrile butadiene styrene polymer, the same glass fiber, and a standard strength steel fiber instead of a high strength steel fiber; and wherein the standard strength steel fiber has a single fiber strength of less than or equal to about 19 cN and an elongation of less than or equal to about 1.5%.

In a further aspect, the invention pertains to electromagnetic wave shielding thermoplastic resin compositions, comprising a) a continuous thermoplastic polymer phase comprising from about 30 wt % to about 75 wt % of a blend of a polycarbonate and an acrylonitrile butadiene styrene polymer; and b) a dispersed phase comprising a plurality stainless steel fibers and glass fibers dispersed within the continuous thermoplastic polymer phase; i) wherein the high strength stainless steel fibers are present in an amount of about 20 wt %; wherein the high strength stainless steel fiber has a single fiber strength of greater than or equal to about 20 cN and an elongation of greater than or equal to about 2%; and ii) wherein the glass fibers are present in an amount from about 0 wt % to about 30 wt %; wherein the composition exhibits electromagnetic wave shielding performance of at least about 60 dB when determined on a 1.2 mm thick sample.

In a further aspect, the invention pertains to electromagnetic wave shielding thermoplastic resin compositions, comprising a) a continuous thermoplastic polymer phase comprising from about 30 wt % to about 75 wt % of a blend of a polycarbonate and an acrylonitrile butadiene styrene polymer; and b) a dispersed phase comprising a plurality stainless steel fibers and glass fibers dispersed within the continuous thermoplastic polymer phase; i) wherein the high strength stainless steel fibers are present in an amount of about 15 wt %; wherein the high strength stainless steel fiber has a single fiber strength of greater than or equal to about 20 cN and an elongation of greater than or equal to about 2%; and ii) wherein the glass fibers are present in an amount from about 0 wt % to about 30 wt %; wherein the composition exhibits electromagnetic wave shielding performance of at least about 60 dB when determined on a 1.2 mm thick sample.

In a further aspect, the invention pertains to electromagnetic wave shielding thermoplastic resin compositions, comprising: a) a continuous thermoplastic polymer phase comprising: i) from about 30 wt % to about 75 wt % of a blend of a polycarbonate and an acrylonitrile-butadiene-styrene copolymer (ABS); and ii) from about 5 wt % to about 20 wt % of a polysiloxane-polycarbonate copolymer; and b) a dispersed phase comprising a plurality stainless steel fibers and glass fibers dispersed within the continuous thermoplastic polymer phase; i) wherein the high strength stainless steel fibers are present in an amount of about 20 wt %; wherein the high strength stainless steel fiber has a single fiber strength of greater than or equal to about 20 cN and an elongation of greater than or equal to about 2%; and ii) wherein the glass fibers are present in an amount from about 0 wt % to about 30 wt %; wherein the composition exhibits electromagnetic wave shielding performance at least about 18% greater when determined on a 1.5 mm thick sample compared to that of a reference composition consisting of substantially the same proportions of the blend of a polycarbonate and an acrylonitrile-butadiene-styrene copolymer (ABS), the same glass fiber, and a standard strength steel fiber instead of a high strength steel fiber; and wherein the standard strength steel fiber has a single fiber strength of less than or equal to about 19 cN and an elongation of less than or equal to about 1.5%.

In a further aspect, the invention pertains to electromagnetic wave shielding thermoplastic resin compositions, comprising: a) a continuous thermoplastic polymer phase comprising: i) from about 30 wt % to about 75 wt % of a blend of a polycarbonate and an acrylonitrile-butadiene-styrene copolymer (ABS); and ii) from about 5 wt % to about 20 wt % of a polysiloxane-polycarbonate copolymer; and b) a dispersed phase comprising a plurality stainless steel fibers and glass fibers dispersed within the continuous thermoplastic polymer phase; i) wherein the high strength stainless steel fibers are present in an amount of about 15 wt %; wherein the high strength stainless steel fiber has a single fiber strength of greater than or equal to about 20 cN and an elongation of greater than or equal to about 2%; and ii) wherein the glass fibers are present in an amount from about 0 wt % to about 30 wt %; wherein the composition exhibits electromagnetic wave shielding performance at least about 18% greater when determined on a 1.5 mm thick sample compared to that of a reference composition consisting of substantially the same proportions of the blend of a polycarbonate and an acrylonitrile-butadiene-styrene copolymer (ABS), the same glass fiber, and a standard strength steel fiber instead of a high strength steel fiber; and wherein the standard strength steel fiber has a single fiber strength of less than or equal to about 19 cN and an elongation of less than or equal to about 1.5%.

In a further aspect, the invention pertains to electromagnetic wave shielding thermoplastic resin compositions, comprising: a) a continuous thermoplastic polymer phase comprising: i) from about 30 wt % to about 75 wt % of a blend of a polycarbonate and an acrylonitrile-butadiene-styrene copolymer (ABS); and ii) from about 5 wt % to about 20 wt % of a polysiloxane-polycarbonate copolymer; and b) a dispersed phase comprising a plurality stainless steel fibers and glass fibers dispersed within the continuous thermoplastic polymer phase; wherein the high strength stainless steel fibers are present in an amount of about 20 wt %; wherein the high strength stainless steel fiber has a single fiber strength of greater than or equal to about 20 cN and an elongation of greater than or equal to about 2%; and ii) wherein the glass fibers are present in an amount from about 0 wt % to about 30 wt %; wherein the composition exhibits electromagnetic wave shielding performance of at least about 57 dB when determined on a 1.5 mm thick sample.

In a further aspect, the invention pertains to electromagnetic wave shielding thermoplastic resin compositions, comprising: a) a continuous thermoplastic polymer phase comprising: i) from about 30 wt % to about 75 wt % of a blend of a polycarbonate and an acrylonitrile-butadiene-styrene copolymer (ABS); and ii) from about 5 wt % to about 20 wt % of a polysiloxane-polycarbonate copolymer; and b) a dispersed phase comprising a plurality stainless steel fibers and glass fibers dispersed within the continuous thermoplastic polymer phase; i) wherein the high strength stainless steel fibers are present in an amount of about 15 wt %; wherein the high strength stainless steel fiber has a single fiber strength of greater than or equal to about 20 cN and an elongation of greater than or equal to about 2%; and ii) wherein the glass fibers are present in an amount from about 0 wt % to about 30 wt %; wherein the composition exhibits electromagnetic wave shielding performance of at least about 52 dB when determined on a 1.5 mm thick sample.

In a further aspect, the invention pertains to electromagnetic wave shielding thermoplastic resin compositions, comprising: a) a continuous thermoplastic polymer phase comprising: i) from about 30 wt % to about 75 wt % of a blend of a polycarbonate and an acrylonitrile-butadiene-styrene copolymer (ABS); and ii) from about 5 wt % to about 20 wt % of a polysiloxane-polycarbonate copolymer; and b) a dispersed phase comprising a plurality stainless steel fibers and glass fibers dispersed within the continuous thermoplastic polymer phase; i) wherein the high strength stainless steel fibers are present in an amount of about 20 wt %; wherein the high strength stainless steel fiber has a single fiber strength of greater than or equal to about 20 cN and an elongation of greater than or equal to about 2%; and ii) wherein the glass fibers are present in an amount from about 0 wt % to about 30 wt %; wherein the composition exhibits electromagnetic wave shielding performance at least about 30% greater when determined on a 1.2 mm thick sample compared to that of a reference composition consisting of substantially the same proportions of the blend of a polycarbonate and an acrylonitrile-butadiene-styrene copolymer (ABS), the same glass fiber, and a standard strength steel fiber instead of a high strength steel fiber; and wherein the standard strength steel fiber has a single fiber strength of less than or equal to about 19 cN and an elongation of less than or equal to about 1.5%.

In a further aspect, the invention pertains to electromagnetic wave shielding thermoplastic resin compositions, comprising: a) a continuous thermoplastic polymer phase comprising: i) from about 30 wt % to about 75 wt % of a blend of a polycarbonate and an acrylonitrile-butadiene-styrene copolymer (ABS); and ii) from about 5 wt % to about 20 wt % of a polysiloxane-polycarbonate copolymer; and b) a dispersed phase comprising a plurality stainless steel fibers and glass fibers dispersed within the continuous thermoplastic polymer phase; i) wherein the high strength stainless steel fibers are present in an amount of about 15 wt %; wherein the high strength stainless steel fiber has a single fiber strength of greater than or equal to about 20 cN and an elongation of greater than or equal to about 2%; and ii) wherein the glass fibers are present in an amount from about 0 wt % to about 30 wt %; wherein the composition exhibits electromagnetic wave shielding performance at least about 42% greater when determined on a 1.2 mm thick sample compared to that of a reference composition consisting of substantially the same proportions of the blend of a polycarbonate and an acrylonitrile-butadiene-styrene copolymer (ABS), the same glass fiber, and a standard strength steel fiber instead of a high strength steel fiber; and wherein the standard strength steel fiber has a single fiber strength of less than or equal to about 19 cN and an elongation of less than or equal to about 1.5%.

In a further aspect, the invention pertains to electromagnetic wave shielding thermoplastic resin compositions, comprising: a) a continuous thermoplastic polymer phase comprising: i) from about 30 wt % to about 75 wt % of a blend of a polycarbonate and an acrylonitrile-butadiene-styrene copolymer (ABS); and ii) from about 5 wt % to about 20 wt % of a polysiloxane-polycarbonate copolymer; and b) a dispersed phase comprising a plurality stainless steel fibers and glass fibers dispersed within the continuous thermoplastic polymer phase; i) wherein the high strength stainless steel fibers are present in an amount of about 20 wt %; wherein the high strength stainless steel fiber has a single fiber strength of greater than or equal to about 20 cN and an elongation of greater than or equal to about 2%; and ii) wherein the glass fibers are present in an amount from about 0 wt % to about 30 wt %; wherein the composition exhibits electromagnetic wave shielding performance of at least about 60 dB when determined on a 1.2 mm thick sample.

In a further aspect, the invention pertains to electromagnetic wave shielding thermoplastic resin compositions, comprising: a) a continuous thermoplastic polymer phase comprising: i) from about 30 wt % to about 75 wt % of a blend of a polycarbonate and an acrylonitrile-butadiene-styrene copolymer (ABS); and ii) from about 5 wt % to about 20 wt % of a polysiloxane-polycarbonate copolymer; and b) a dispersed phase comprising a plurality stainless steel fibers and glass fibers dispersed within the continuous thermoplastic polymer phase; i) wherein the high strength stainless steel fibers are present in an amount of about 15 wt %; wherein the high strength stainless steel fiber has a single fiber strength of greater than or equal to about 20 cN and an elongation of greater than or equal to about 2%; and ii) wherein the glass fibers are present in an amount from about 0 wt % to about 30 wt %; wherein the composition exhibits electromagnetic wave shielding performance of at least about 60 dB when determined on a 1.2 mm thick sample.

In various aspects, the electromagnetic wave shielding performance is at least about 11% greater compared to that of the reference composition when measured according to ASTM D4935 using a 1.5 mm thick sample. In a further aspect, the electromagnetic wave shielding performance is at least about 12% greater compared to that of the reference composition when measured according to ASTM D4935 using a 1.5 mm thick sample. In a still further aspect, the electromagnetic wave shielding performance is at least about 13% greater compared to that of the reference composition when measured according to ASTM D4935 using a 1.5 mm thick sample. In a yet further aspect, the electromagnetic wave shielding performance is at least about 14% greater compared to that of the reference composition when measured according to ASTM D4935 using a 1.5 mm thick sample. In an even further aspect, the electromagnetic wave shielding performance is at least about 15% greater compared to that of the reference composition when measured according to ASTM D4935 using a 1.5 mm thick sample. In a still further aspect, the electromagnetic wave shielding performance is at least about 16% greater compared to that of the reference composition when measured according to ASTM D4935 using a 1.5 mm thick sample. In a yet further aspect, the electromagnetic wave shielding performance is at least about 17% greater compared to that of the reference composition when measured according to ASTM D4935 using a 1.5 mm thick sample. In an even further aspect, the electromagnetic wave shielding performance is at least about 30% greater compared to that of the reference composition when measured according to ASTM D4935 using a 1.5 mm thick sample.

In a further aspect, the electromagnetic wave shielding performance is at least about 50 db when measured according to ASTM D4935 using a 1.5 mm thick sample. In a still further aspect, the electromagnetic wave shielding performance is at least about 52 db when measured according to ASTM D4935 using a 1.5 mm thick sample. In a yet further aspect, the electromagnetic wave shielding performance is at least about 54 db when measured according to ASTM D4935 using a 1.5 mm thick sample. In an even further aspect, the electromagnetic wave shielding performance is at least about 56 db when measured according to ASTM D4935 using a 1.5 mm thick sample. In a still further aspect, the electromagnetic wave shielding performance is at least about 58 db when measured according to ASTM D4935 using a 1.5 mm thick sample. In a yet further aspect, the electromagnetic wave shielding performance is at least about 59 db when measured according to ASTM D4935 using a 1.5 mm thick sample. In an even further aspect, the electromagnetic wave shielding performance is at least about 60 db when measured according to ASTM D4935 using a 1.5 mm thick sample.

In various aspects, the electromagnetic wave shielding performance is at least about 31% greater compared to that of the reference composition when measured according to ASTM D4935 using a 1.2 mm thick sample. In a further aspect, the electromagnetic wave shielding performance is at least about 32% greater compared to that of the reference composition when measured according to ASTM D4935 using a 1.2 mm thick sample. In a still further aspect, the electromagnetic wave shielding performance is at least about 33% greater compared to that of the reference composition when measured according to ASTM D4935 using a 1.2 mm thick sample. In a yet further aspect, the electromagnetic wave shielding performance is at least about 34% greater compared to that of the reference composition when measured according to ASTM D4935 using a 1.2 mm thick sample. In an even further aspect, the electromagnetic wave shielding performance is at least about 35% greater compared to that of the reference composition when measured according to ASTM D4935 using a 1.2 mm thick sample.

In a further aspect, the electromagnetic wave shielding performance is at least about 40 db when measured according to ASTM D4935 using a 1.2 mm thick sample. In a still further aspect, the electromagnetic wave shielding performance is at least about 45 db when measured according to ASTM D4935 using a 1.2 mm thick sample. In a yet further aspect, the electromagnetic wave shielding performance is at least about 46 db when measured according to ASTM D4935 using a 1.2 mm thick sample. In an even further aspect, the electromagnetic wave shielding performance is at least about 47 db when measured according to ASTM D4935 using a 1.2 mm thick sample. In a still further aspect, the electromagnetic wave shielding performance is at least about 48 db when measured according to ASTM D4935 using a 1.2 mm thick sample. In a yet further aspect, the electromagnetic wave shielding performance is at least about 49 db when measured according to ASTM D4935 using a 1.2 mm thick sample. In an even further aspect, the electromagnetic wave shielding performance is at least about 50 db when measured according to ASTM D4935 using a 1.2 mm thick sample. In a still further aspect, the electromagnetic wave shielding performance is at least about 51 db when measured according to ASTM D4935 using a 1.2 mm thick sample. In a yet further aspect, the electromagnetic wave shielding performance is at least about 52 db when measured according to ASTM D4935 using a 1.2 mm thick sample.

In various aspects, the composition further exhibits a Notched Izod Impact strength of greater than or equal to about 50 J/m when as measured according to ASTM D256. In a further aspect, the composition further exhibits a Notched Izod Impact strength of greater than or equal to about 52 J/m when as measured according to ASTM D256. In a still further aspect, the composition further exhibits a Notched Izod Impact strength of greater than or equal to about 54 J/m when as measured according to ASTM D256. In a yet further aspect, the composition further exhibits a Notched Izod Impact strength of greater than or equal to about 56 J/m when as measured according to ASTM D256. In an even further aspect, the composition further exhibits a Notched Izod Impact strength of greater than or equal to about 58 J/m when as measured according to ASTM D256. In a still further aspect, the composition further exhibits a Notched Izod Impact strength of greater than or equal to about 60 J/m when as measured according to ASTM D256.

In various aspects, the composition further exhibits a heat deflection temperature of greater than or equal to about 92° C. when measured according to ASTM D648. In a further aspect, the composition further exhibits a heat deflection temperature of greater than or equal to about 93° C. when measured according to ASTM D648. In a still further aspect, the composition further exhibits a heat deflection temperature of greater than or equal to about 94° C. when measured according to ASTM D648. In a yet further aspect, the composition further exhibits a heat deflection temperature of greater than or equal to about 95° C. when measured according to ASTM D648. In an even further aspect, the composition further exhibits a heat deflection temperature of greater than or equal to about 96° C. when measured according to ASTM D648. In a still further aspect, the composition further exhibits a heat deflection temperature of greater than or equal to about 97° C. when measured according to ASTM D648.

In a further aspect, the continuous thermoplastic polymer phase further comprises a polysiloxane-polycarbonate copolymer.

In a further aspect, the continuous thermoplastic polymer phase further comprises at least one polymer additive selected from an antioxidant, heat stabilizer, light stabilizer, ultraviolet light absorber, plasticizer, mold release agent, lubricant, antistatic agent, pigment, dye, and gamma stabilizer. In a still further aspect, the continuous thermoplastic polymer phase further comprises at least one polymer additive selected from a flame retardant, a colorant, a primary anti-oxidant, and a secondary anti-oxidant.

In a further aspect, the continuous thermoplastic polymer phase further comprises a second impact modifier; and wherein the second impact modifier is different than the acrylonitrile butadiene styrene polymer used in the blend of polycarbonate and acrylonitrile butadiene styrene polymer.

### Polycarbonate Polymer Compositions

In one aspect, the disclosed electromagnetic wave shielding thermoplastic resin compositions comprise a continuous thermoplastic polymer phase, wherein the continuous thermoplastic polymer comprises a polycarbonate. It should be understood that the polycarbonate of the shielding thermoplastic resin compositions can be referred to herein as “polycarbonate,” “polycarbonate resin,” “polycarbonate compound,” or “polycarbonate composition.”

As used herein, the term “polycarbonate” and “polycarbonate resin” includes homopolycarbonates and copolycarbonates have repeating structural carbonate units, wherein the structural units are derived from one or more dihydroxy aromatic compounds and includes copolycarbonates and polyestercarbonates. In one aspect, a polycarbonate can comprise any polycarbonate material or mixture of materials, for example, as recited in U.S. Pat. No. 7,786,246, which is hereby incorporated in its entirety for the specific purpose of disclosing various polycarbonate compositions and methods. The term polycarbonate can be further defined as compositions have repeating structural units of the formula (1):

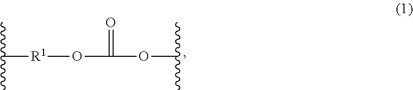

in which at least 60 percent of the total number of R¹ groups are aromatic organic radicals and the balance thereof are aliphatic, alicyclic, or aromatic radicals. Preferably, each R¹ is an aromatic organic radical and, including, for example, a radical of the formula (2):

-A¹-Y¹-A²- (2),

wherein each of A¹ and A² is a monocyclic divalent aryl radical and Y¹ is a bridging radical having one or two atoms that separate A¹ from A². In various aspects, one atom separates A¹ from A². For example, radicals of this type include, but are not limited to, radicals such as —O—, —S—, —S(O)—, —S(O₂)—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ is preferably a hydrocarbon group or a saturated hydrocarbon group such as methylene, cyclohexylidene, or isopropylidene.

In a further aspect, polycarbonates can be produced by the interfacial reaction of dihydroxy compounds having the formula HO—R¹—OH, which includes dihydroxy compounds of formula (3):

HO-A¹-Y¹-A²-OH (3),

wherein Y¹, A¹ and A² are as described above. Also included are bisphenol compounds of general formula (4):

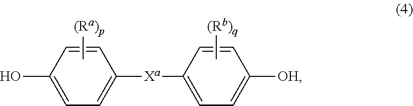

wherein R^{a} and R^{b} each represent a halogen atom or a monovalent hydrocarbon group and may be the same or different; p and q are each independently integers from 0 to 4; and X^{a} represents one of the groups of formula (5):

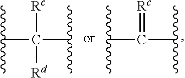

wherein R^{c} and R^{d} each independently represent a hydrogen atom or a monovalent linear or cyclic hydrocarbon group and R^{e} is a divalent hydrocarbon group.

In various further aspects, examples of suitable dihydroxy compounds include the dihydroxy-substituted hydrocarbons disclosed by name or formula (generic or specific) in U.S. Pat. No. 4,217,438. A nonexclusive list of specific examples of suitable dihydroxy compounds includes the following: resorcinol, 4-bromoresorcinol, hydroquinone, 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, (alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, 2,7-dihydroxycarbazole, 3,3-bis(4-hydroxyphenyl)phthalimidine, 2-phenyl-3,3-bis-(4-hydroxyphenyl)phthalimidine (PPPBP), and the like, as well as mixtures including at least one of the foregoing dihydroxy compounds.

In a further aspect, examples of the types of bisphenol compounds that may be represented by formula (3) includes 1,1-bis(4-hydroxyphenyl)methane, 1,1-bis(4-hydroxyphenyl)ethane, 2,2-bis(4-hydroxyphenyl)propane (hereinafter “bisphenol A” or “BPA”), 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, and 1,1-bis(4-hydroxy-t-butylphenyl)propane. Combinations including at least one of the foregoing dihydroxy compounds may also be used.

Other useful dihydroxy compounds include aromatic dihydroxy compounds of formula (6):

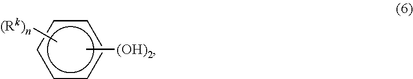

wherein each R^{k}, is independently a C₁₋₁₀ hydrocarbon group, and n is 0 to 4. The halogen is usually bromine. Examples of compounds that may be represented by the formula (6) include resorcinol, substituted resorcinol compounds such as 5-methyl resorcinol, 5-phenyl resorcinol, 5-cumyl resorcinol, or the like; catechol; hydroquinone; substituted hydroquinones such as 2-methyl hydroquinone, 2-t-butyl hydroquinone, 2-phenyl hydroquinone, 2-cumyl hydroquinone, 2,3,5,6-tetramethyl hydroquinone, or the like; or combinations comprising at least one of the foregoing compounds.

Polycarbonates may be branched. The branched polycarbonates may be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane (THPE), isatin-bis-phenol, tris-phenol TC (1,3,5-tris((p-hydroxyphenyl)isopropyl)benzene), tris-phenol PA (4(4(1,1-bis(p-hydroxyphenyl)-ethyl)alpha, alpha-dimethyl benzyl)phenol), 4-chloroformyl phthalic anhydride, trimesic acid, and benzophenone tetracarboxylic acid. The branching agents may be added at a level of about 0.05 wt % to about 2.0 wt %.

In various aspects, the dihydroxy compound used to form the polycarbonate has the structure of formula (7):

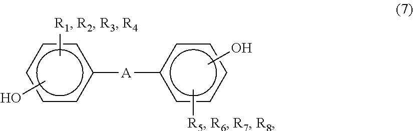

wherein R₁ through R₈ are each independently selected from hydrogen, nitro, cyano, C₁-C₂₀ alkyl, C₄-C₂₀ cycloalkyl, and C₆-C₂₀ aryl; and A is selected from a bond, —O—, —S—, —SO₂—, C₁-C₁₂ alkyl, C₆-C₂₀ aromatic, and C₆-C₂₀ cycloaliphatic.

In various aspects, the dihydroxy compound of formula (7) is 2,2-bis(4-hydroxyphenyl)propane (i.e. bisphenol-A or BPA). Other illustrative compounds of formula (7) include: 2,2-bis(4-hydroxy-3-isopropylphenyl)propane; 2,2-bis(3-t-butyl-4-hydroxyphenyl)propane; 2,2-bis(3-phenyl-4-hydroxyphenyl)propane; 1,1-bis(4-hydroxyphenyl)cyclohexane; 4,4′-dihydroxy-1,1-biphenyl; 4,4′-dihydroxy-3,3′-dimethyl-1,1-biphenyl; 4,4′-dihydroxy-3,3′-dioctyl-1,1-biphenyl; 4,4′-dihydroxydiphenylether; 4,4′-dihydroxydiphenylthioether; and 1,3-bis(2-(4-hydroxyphenyl)-2-propyl)benzene.

The polycarbonate compositions of the present invention can contain at least two polycarbonate copolymers. First, the polycarbonate compositions of the present disclosure contain at least one poly(aliphatic ester)-polycarbonate copolymer. The poly(aliphatic ester)-polycarbonate copolymer is made up of a combination of carbonate units and aliphatic ester units. The molar ratio of ester units to carbonate units can vary widely, for example from 1:99 to 99:1, or more specifically from 25:75 to 75:25, depending on the desired properties of the final compositions.

In a further aspect, the ester unit may have the structure of formula (8):

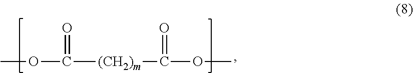

wherein m is from about 4 to about 18. In some embodiments, m is from about 8 to about 10. The ester units may be derived from a C₆-C₂₀ aliphatic dicarboxylic acid (which includes the terminal carboxylate groups) or a reactive derivative thereof, including a C₈-C₁₂aliphatic dicarboxylic acid. In various aspects, the terminal carboxylate groups are derived from the corresponding dicarboxylic acid or reactive derivative thereof, such as the acid halide (specifically, the acid chloride), an ester, or the like. Exemplary dicarboxylic acids (from which the corresponding acid chlorides may be derived) include C₆ dicarboxylic acids such as hexanedioic acid (also referred to as adipic acid); C₁₀ dicarboxylic acids such as decanedioic acid (also referred to as sebacic acid); and alpha, omega C₁₂ dicarboxylic acids such as dodecanedioic acid (sometimes abbreviated as DDDA). It will be appreciated that the aliphatic dicarboxylic acid is not limited to these exemplary carbon chain lengths, and that other chain lengths within the C₆-C₂₀ range may be used.

In a further aspect, an example of the poly(aliphatic ester)-polycarbonate copolymer having ester units comprising a straight chain methylene group and a polycarbonate group is shown in formula (9):

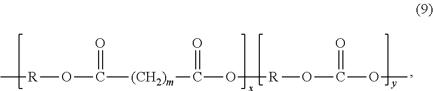

where m is 4 to 18; x and y represent average molar percentages of the aliphatic ester units and the carbonate units in the copolymer. The average molar percentage ratio x:y may be from 99:1 to 1:99, including from about 13:87 to about 2:98, or from about 9:91 to about 2:98 or from about 8:92 to 13:87. Each R may be independently derived from a dihydroxy compound. In a specific exemplary embodiment, a useful poly(aliphatic ester)-polycarbonate copolymer comprises sebacic acid ester units and bisphenol A carbonate units (formula (8), where m is 8, and the average molar ratio of x:y is 6:94). Such poly(aliphatic ester)-polycarbonate copolymers are commercially available as LEXAN HFD copolymers (LEXAN is a trademark of SABIC Innovative Plastics IP B. V.). In a further aspect, the poly(aliphatic ester)-polycarbonate copolymer can contain additional monomers if desired.

In various aspects, the poly(aliphatic ester) polycarbonate copolymer may have a weight average molecular weight of from about 15,000 to about 40,000, including from about 20,000 to about 38,000 (measured by GPC based on BPA polycarbonate standards). The polycarbonate compositions of the present disclosure may include from about 20 wt % to about 85 wt % of the poly(aliphatic ester)-polycarbonate copolymer.

In a further aspect of the present invention, the polycarbonate composition includes two poly(aliphatic ester)-polycarbonate copolymers, i.e. a first poly(aliphatic ester)-polycarbonate copolymer and a second poly(aliphatic ester)-polycarbonate copolymer. The two poly(aliphatic ester)-polycarbonate copolymers may have the same or different ester unit and the same or different carbonate unit.

The first poly(aliphatic ester)-polycarbonate copolymer has a lower weight average molecular weight than the second poly(aliphatic ester)-polycarbonate copolymer. The first poly(aliphatic ester)-polycarbonate copolymer may have a weight average molecular weight of from about 15,000 to about 25,000, including from about 20,000 to about 22,000 as measured by GPC based on BPA polycarbonate standards. Referring to formula (9), the first poly(aliphatic ester)-polycarbonate copolymer may have an average molar percentage ratio x:y of from about 7:93 to about 13:87. The second poly(aliphatic ester)-polycarbonate copolymer may have a weight average molecular weight of 30,000 to about 40,000, including from about 35,000 to about 38,000 as measured by GPC based on BPA polycarbonate standards. Referring to Formula (9), the second poly(aliphatic ester)-polycarbonate copolymer may have an average molar percentage ratio x:y of from about 4:96 to about 7:93. In embodiments, the weight ratio of the first poly(aliphatic ester)-polycarbonate copolymer to the second poly(aliphatic ester)-polycarbonate copolymer may be from about 1:4 to about 5:2 (i.e. from about 0.25 to about 2.5). Note the weight ratio described here is the ratio of the amounts of the two copolymers in the composition, not the ratio of the molecular weights of the two copolymers. The weight ratio between the two poly(aliphatic ester)-polycarbonate copolymers will affect the flow properties, ductility, and surface aesthetics of the final composition. In various aspects, the polycarbonate compositions can have more of the higher Mw copolymer than the lower Mw copolymer, i.e. the ratio of the second poly(aliphatic ester)-polycarbonate copolymer to the first poly(aliphatic ester)-polycarbonate copolymer is from 0:1 to 1:1. In a further aspect, the polycarbonate compositions can have more of the lower Mw copolymer than the higher Mw copolymer, i.e. the ratio of the second poly(aliphatic ester)-polycarbonate copolymer to the first poly(aliphatic ester)-polycarbonate copolymer is from 1:1 to about 5:2.

In various aspects, the polycarbonate compositions can include from about 20 to about 85 wt % of the first poly(aliphatic ester)-polycarbonate copolymer (i.e. the lower Mw copolymer) and the second poly(aliphatic ester)-polycarbonate copolymer (i.e. the higher Mw copolymer) combined. The composition can contain from about 10 to about 55 wt % of the first poly(aliphatic ester)-polycarbonate copolymer. The composition may contain from about 5 to about 40 wt % of the second poly(aliphatic ester)-polycarbonate copolymer.

In a further aspect, the polycarbonates are based on bisphenol A, in which each of A¹ and A² is p-phenylene and Y¹ is isopropylidene. In a still further aspect, the molecular weight (Mw) of the polycarbonate is about 10,000 to about 100,000. In a yet further aspect, the polycarbonate has a Mw of about 15,000 to about 55,000. In an even further aspect, the polycarbonate has a Mw of about 18,000 to about 40,000.

XXX

In various aspects, the disclosed electromagnetic wave shielding thermoplastic resin compositions comprise a continuous thermoplastic polymer phase, wherein the continuous thermoplastic polymer comprises a polycarbonate, wherein the polycarbonate comprises a blend of two or more polycarbonate polymers. In a further aspect, the polycarbonate blend comprises a low flow polycarbonate polymer and a high flow polycarbonate polymer.

In a further aspect, the low flow polycarbonate has a melt volume rate (MVR) from about 4.0 to about 8.0 cm3/10 min when measured according to ASTM D1238 at 300° C. under a load of 1.2 kg. In a still further aspect, the low flow polycarbonate has a melt volume rate (MVR) from about 4.5 to about 7.2 cm3/10 min when measured according to ASTM D1238 at 300° C. under a load of 1.2 kg. In a yet further aspect, the low flow polycarbonate has a melt volume rate (MVR) from about 4.8 to about 7.1 cm3/10 min when measured according to ASTM D1238 at 300° C. under a load of 1.2 kg.

In a further aspect, the low flow polycarbonate has a weight average molecular weight from about 18,000 to about 40,000. In a still further aspect, the low flow polycarbonate has a weight average molecular weight from about 18,000 to about 35,000. In a yet further aspect, the low flow polycarbonate has a weight average molecular weight from about 18,000 to about 30,000. In an even further aspect, the low flow polycarbonate has a weight average molecular weight from about 18,000 to about 25,000. In a still further aspect, the low flow polycarbonate has a weight average molecular weight from about 18,000 to about 23,000.

In a further aspect, the high flow polycarbonate has a melt volume rate (MVR) from about 17 to about 32 cm3/10 min when measured according to ASTM D1238 at 300° C. under a load of 1.2 kg. In a still further aspect, the high flow polycarbonate has a melt volume rate (MVR) from about 20 to about 30 cm3/10 min when measured according to ASTM D1238 at 300° C. under a load of 1.2 kg. In a yet further aspect, the high flow polycarbonate has a melt volume rate (MVR) from about 22 to about 29 cm3/10 min when measured according to ASTM D1238 at 300° C. under a load of 1.2 kg.

In a further aspect, the high flow polycarbonate has a weight average molecular weight from about 18,000 to about 40,000. In a still further aspect, the high flow polycarbonate has a weight average molecular weight from about 20,000 to about 35,000. In a yet further aspect, the high flow polycarbonate has a weight average molecular weight from about 20,000 to about 30,000. In an even further aspect, the high flow polycarbonate has a weight average molecular weight from about 23,000 to about 30,000. In a still further aspect, the high flow polycarbonate has a weight average molecular weight from about 25,000 to about 30,000. In a yet further aspect, the high flow polycarbonate has a weight average molecular weight from about 27,000 to about 30,000.

In various aspects, the disclosed electromagnetic wave shielding thermoplastic resin compositions comprise a continuous thermoplastic polymer phase, wherein the continuous thermoplastic polymer comprises a polycarbonate, wherein the polycarbonate is present in an amount from about 25 wt % to about 65 wt %. In a further aspect, the polycarbonate is present in an amount from about 30 wt % to about 60 wt %. In a still further aspect, the polycarbonate is present in an amount from about 55 wt % to about 65 wt %. In a yet further aspect, the polycarbonate is present in an amount from about 40 wt % to about 70 wt %. In an even further aspect, the polycarbonate is present in an amount from about 35 wt % to about 45 wt %.

In a further aspect, the polycarbonate has a weight average molecular weight from about 15,000 to about 50,000. In a still further aspect, the polycarbonate has a weight average molecular weight from about 18,000 to about 40,000. In a yet further aspect, the polycarbonate has a weight average molecular weight from about 18,000 to about 30,000.

In a further aspect, the polycarbonate is a homopolymer derived from bisphenol A residues.

In a further aspect, the weight average molecular weight is as measured by gel permeation chromatography versus polycarbonate reference standards. In a still further aspect, the gel permeation chromatography (GPC) is performed using a crosslinked styrene-divinylbenzene column.

These polycarbonate compounds and polymers can be manufactured by processes known in the art, such as interfacial polymerization and melt polymerization. Although the reaction conditions for interfacial polymerization can vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a suitable catalyst such as triethylamine or a phase transfer catalyst, under controlled pH conditions, e.g., about 8 to about 10. Generally, in the melt polymerization process, polycarbonates can be prepared by co-reacting, in a molten state, the dihydroxy reactant(s) and a diaryl carbonate ester, such as diphenyl carbonate, in the presence of a transesterification catalyst in a Banbury® mixer, twin screw extruder, or the like to form a uniform dispersion. Volatile monohydric phenol is removed from the molten reactants by distillation and the polymer is isolated as a molten residue.

In one aspect, an end-capping agent (also referred to as a chain-stopper) can optionally be used to limit molecular weight growth rate, and so control molecular weight in the polycarbonate. Exemplary chain-stoppers include certain monophenolic compounds (i.e., phenyl compounds having a single free hydroxy group), monocarboxylic acid chlorides, and/or monochloroformates. Phenolic chain-stoppers are exemplified by phenol and C₁-C₂₂ alkyl-substituted phenols such as p-cumyl-phenol, resorcinol monobenzoate, and p- and tertiary-butyl phenol, cresol, and monoethers of diphenols, such as p-methoxyphenol. Alkyl-substituted phenols with branched chain alkyl substituents having 8 to 9 carbon atoms can be specifically mentioned.

In another aspect, endgroups can be derived from the carbonyl source (i.e., the diaryl carbonate), from selection of monomer ratios, incomplete polymerization, chain scission, and the like, as well as any added end-capping groups, and can include derivatizable functional groups such as hydroxy groups, carboxylic acid groups, or the like. In one aspect, the endgroup of a polycarbonate, including a polycarbonate polymer as defined herein, can comprise a structural unit derived from a diaryl carbonate, where the structural unit can be an endgroup. In a further aspect, the endgroup is derived from an activated carbonate. Such endgroups can be derived from the transesterification reaction of the alkyl ester of an appropriately substituted activated carbonate, with a hydroxy group at the end of a polycarbonate polymer chain, under conditions in which the hydroxy group reacts with the ester carbonyl from the activated carbonate, instead of with the carbonate carbonyl of the activated carbonate. In this way, structural units derived from ester containing compounds or substructures derived from the activated carbonate and present in the melt polymerization reaction can form ester endgroups.

### Polysiloxane-Polycarbonate Copolymer

In one aspect, the disclosed electromagnetic wave shielding thermoplastic resin compositions comprise a continuous thermoplastic polymer phase, wherein the continuous thermoplastic polymer comprises a polycarbonate. It should be understood that the polycarbonate of the shielding thermoplastic resin compositions can be referred to herein as “polysiloxane-polycarbonate copolymer,” “polysiloxane-polycarbonate compound,” “polysiloxane-polycarbonate composition,” “polycarbonate-siloxane resin,” “polycarbonate-siloxane compound,” or “polycarbonate-siloxane composition.”

The polysiloxane-polycarbonate copolymer comprises polycarbonate blocks and polydiorganosiloxane blocks. The polycarbonate blocks in the copolymer comprise repeating structural units of formula (1) as described above, for example wherein R¹ is of formula (2) as described above. These units may be derived from reaction of dihydroxy compounds of formula (3) as described above.

The polydiorganosiloxane blocks comprise repeating structural units of formula (10) (sometimes referred to herein as ‘siloxane’):

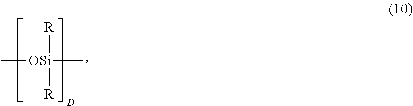

wherein each occurrence of R is same or different, and is a C₁₋₁₃ monovalent organic radical. For example, R may be a C₁-C₁₃ alkyl group, C₁-C₁₃ alkoxy group, C₂-C₁₃ alkenyl group, C₂-C₁₃ alkenyloxy group, C₃-C₆ cycloalkyl group, C₃-C₆ cycloalkoxy group, C₆-C₁₀ aryl group, C₆-C₁₀ aryloxy group, C₇-C₁₃ aralkyl group, C₇-C₁₃ aralkoxy group, C₇-C₁₃ alkaryl group, or C₇-C₁₃ alkaryloxy group. Combinations of the foregoing R groups may be used in the same copolymer. Generally, D may have an average value of 2 to about 1000, specifically about 2 to about 500, more specifically about 30 to about 100, or from about 35 to about 55. Where D is of a lower value, e.g., less than about 40, it may be desirable to use a relatively larger amount of the polycarbonate-polysiloxane copolymer. Conversely, where D is of a higher value, e.g., greater than about 40, it may be necessary to use a relatively lower amount of the polycarbonate-polysiloxane copolymer. D may be referred to as the siloxane block chain length.

In various aspects, the polydiorganosiloxane blocks are provided by repeating structural units of formula (11):

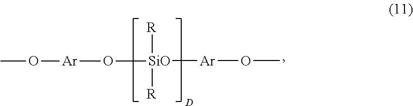

wherein D is as defined above; each R may be the same or different, and is as defined above; and Ar may be the same or different, and is a substituted or unsubstituted C₆-C₃₀ arylene radical, wherein the bonds are directly connected to an aromatic moiety. Suitable Ar groups in formula (11) may be derived from a C₆-C₃₀ dihydroxyarylene compound, for example a dihydroxyarylene compound of formula (3), (4), or (6) above. Combinations comprising at least one of the foregoing dihydroxyarylene compounds may also be used.

Such units may be derived from the corresponding dihydroxy compound of the following formula (12):

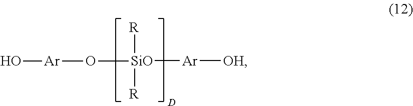

wherein Ar and D are as described above. Compounds of this formula may be obtained by the reaction of a dihydroxyarylene compound with, for example, an alpha, omega-bisacetoxypolydiorangonosiloxane under phase transfer conditions.

In a further aspect, the polydiorganosiloxane blocks comprise repeating structural units of formula (13):

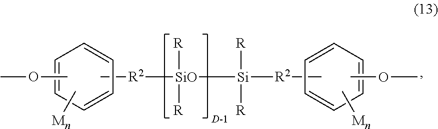

wherein R and D are as defined above. R² in formula (13) is a divalent C₂-C₈ aliphatic group. Each M in formula (13) may be the same or different, and may be cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ aralkyl, C₇-C₁₂ aralkoxy, C₇-C₁₂ alkaryl, or C₇-C₁₂ alkaryloxy, wherein each n is independently 0, 1, 2, 3, or 4.

In a further aspect, M is an alkyl group such as methyl, ethyl, or propyl, an alkoxy group such as methoxy, ethoxy, or propoxy, or an aryl group such as phenyl, or tolyl; R² is a dimethylene, trimethylene, or tetramethylene group; and R is a C₁₋₈ alkyl, haloalkyl such as trifluoropropyl, cyanoalkyl, or aryl such as phenyl or tolyl. In another embodiment, R is methyl, or a mixture of methyl and phenyl. In still another embodiment, M is methoxy, n is one, R² is a divalent C₁-C₃ aliphatic group, and R is methyl.

These units may be derived from the corresponding dihydroxy polydiorganosiloxane (14):

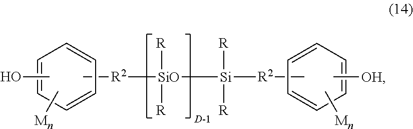

wherein R, D, M, R², and n are as described above.

Such dihydroxy polysiloxanes can be made by effecting a platinum catalyzed addition between a siloxane hydride of the formula (15):

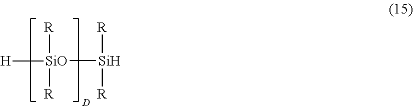

wherein R and D are as previously defined, and an aliphatically unsaturated monohydric phenol. Suitable aliphatically unsaturated monohydric phenols included, for example, eugenol, 2-allylphenol, 4-allylphenol, 4-allyl-2-methylphenol, 4-allyl-2-phenylphenol, 4-allyl-2-t-butoxyphenol, 4-phenyl-2-phenylphenol, 2-methyl-4-propylphenol, 2-allyl-4,6-dimethylphenol, 2-allyl-6-methoxy-4-methylphenol and 2-allyl-4,6-dimethylphenol. Mixtures comprising at least one of the foregoing may also be used.

In a further aspect, wherein Ar of formula (11) is derived from resorcinol, the polydiorganosiloxane repeating units are derived from polysiloxane bisphenols of formula (16):

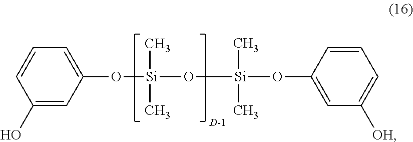

or, where Ar is derived from bisphenol A, from polysiloxane bisphenols of formula (17):

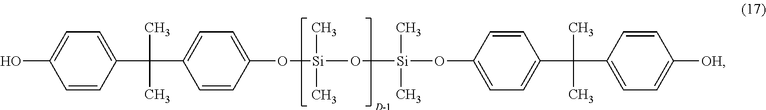

wherein D is as defined above.

In a further aspect, the polysiloxane units are derived from a polysiloxane bisphenol of formula (18):

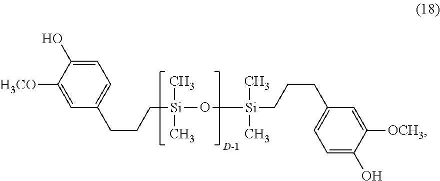

wherein D is as described in formula (10).

In a further aspect, the polysiloxane units are derived from polysiloxane bisphenol of formula (19):

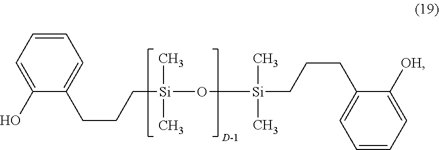

wherein D is as described in formula (10).

In a further aspect, the polysiloxane-polycarbonate copolymer can contain additional monomers if desired.

In various aspects, the polysiloxane-polycarbonate copolymer is present in the disclosed compositions in an amount from about 1 wt % to about 30 wt %. In a further aspect, the polysiloxane-polycarbonate copolymer is present in the disclosed compositions in an amount from about 5 wt % to about 25 wt %. In a still further aspect, the polysiloxane-polycarbonate copolymer is present in the disclosed compositions in an amount from about 5 wt % to about 20 wt %. In a yet further aspect, the polysiloxane-polycarbonate copolymer is present in the disclosed compositions in an amount from about 7.5 wt % to about 17.5 wt %. In an even further aspect, the polysiloxane-polycarbonate copolymer is present in the disclosed compositions in an amount from about 10 wt % to about 17 wt %. In a still further aspect, the polysiloxane-polycarbonate copolymer is present in the disclosed compositions in an amount of about 12 wt %. In a yet further aspect, the polysiloxane-polycarbonate copolymer is present in the disclosed compositions in an amount of about 16 wt %.

In various aspects, the siloxane blocks can make up from greater than zero to about 25 wt % of the polysiloxane-polycarbonate copolymer, including from about 4 wt % to about 25 wt %, from about 4 wt % to about 10 wt %, or from about 15 wt % to about 25 wt %. In a further aspect, the polysiloxane-polycarbonate copolymer comprises a siloxane blocks from about 5 wt % to about 30 wt % of the polysiloxane-polycarbonate copolymer. In a still further aspect, the polysiloxane-polycarbonate copolymer comprises a siloxane blocks from about 10 wt % to about 25 wt % of the polysiloxane-polycarbonate copolymer. In a yet further aspect, the polysiloxane-polycarbonate copolymer comprises a siloxane blocks from about 15 wt % to about 25 wt % of the polysiloxane-polycarbonate copolymer. In an even further aspect, the polysiloxane-polycarbonate copolymer comprises a siloxane blocks from about 17.5 wt % to about 22.5 wt % of the polysiloxane-polycarbonate copolymer. In a still further aspect, the polysiloxane-polycarbonate copolymer comprises a siloxane blocks of about 20 wt % of the polysiloxane-polycarbonate copolymer.

In a further aspect, the polysiloxane-polycarbonate copolymer comprises siloxane blocks less than about 10 wt % of the polysiloxane-polycarbonate copolymer. In a still further aspect, the polysiloxane-polycarbonate copolymer comprises siloxane blocks less than about 8 wt % of the polysiloxane-polycarbonate copolymer. In a yet further aspect, the polysiloxane-polycarbonate copolymer comprises siloxane blocks less than about 6 wt % of the polysiloxane-polycarbonate copolymer.

In a further aspect, the polycarbonate blocks can make up from about 75 wt % to less than 100 wt % of the block copolymer, including from about 75 wt % to about 85 wt %. It is specifically contemplated that the polysiloxane-polycarbonate copolymer is a diblock copolymer. In a further aspect, the polysiloxane-polycarbonate copolymer comprises a polycarbonate block from about 60 wt % to about 85 wt % of the polysiloxane-polycarbonate copolymer. In a still further aspect, the polysiloxane-polycarbonate copolymer comprises a polycarbonate block from about 70 wt % to about 85 wt % of the polysiloxane-polycarbonate copolymer. In a yet further aspect, the polysiloxane-polycarbonate copolymer comprises a polycarbonate block from about 75 wt % to about 85 wt % of the polysiloxane-polycarbonate copolymer. In an even further aspect, the polysiloxane-polycarbonate copolymer comprises a polycarbonate block of about 80 wt % of the polysiloxane-polycarbonate copolymer.

In a further aspect, the polysiloxane-polycarbonate copolymer may have a weight average molecular weight of from about 28,000 to about 32,000. In a still further aspect, the polysiloxane-polycarbonate copolymer may have a weight average molecular weight offrom about 25,000 to about 42,000. In a yet further aspect, the polysiloxane-polycarbonate copolymer may have a weight average molecular weight of from about 28,000 to about 30,000.

In a further aspect, the polycarbonate compositions of the present disclosure may include from about 5 to about 70 wt % of the polysiloxane-polycarbonate copolymer, including from about 5 wt % to about 20 wt % or from about 15 wt % to about 65 wt %. In particular embodiments, the composition comprises from about 0.5 wt % to about 6 wt % of siloxane originating from the polysiloxane-polycarbonate copolymer. Exemplary commercially available polysiloxane-polycarbonate copolymers are sold under the mark LEXAN® EXL by SABIC Innovative Plastics IP B. V.

The polysiloxane-polycarbonate copolymer can be manufactured by processes known in the art, such as interfacial polymerization and melt polymerization. Although the reaction conditions for interfacial polymerization may vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a suitable catalyst such as triethylamine or a phase transfer catalyst, under controlled pH conditions, e.g., about 8 to about 10. Generally, in the melt polymerization process, polycarbonates may be prepared by co-reacting, in a molten state, the dihydroxy reactant(s) and a diaryl carbonate ester, such as diphenyl carbonate, in the presence of a transesterification catalyst in a Banbury® mixer, twin screw extruder, or the like to form a uniform dispersion. Volatile monohydric phenol is removed from the molten reactants by distillation and the polymer is isolated as a molten residue.

### Impact Modifier

In one aspect, the disclosed electromagnetic wave shielding thermoplastic resin compositions with improved electromagnetic wave shielding of the present invention comprise one or more impact modifying agents, or impact modifiers, blended with a disclosed polycarbonate. In a further aspect, a suitable impact modifier is a acrylonitrile-butadiene-styrene polymer.

Acrylonitrile-butadiene-styrene (“ABS”) graft copolymers contain two or more polymeric parts of different compositions, which are bonded chemically. The graft copolymer is specifically prepared by first polymerizing a conjugated diene, such as butadiene or another conjugated diene, with a monomer copolymerizable therewith, such as styrene, to provide a polymeric backbone. After formation of the polymeric backbone, at least one grafting monomer, and specifically two, are polymerized in the presence of the polymer backbone to obtain the graft copolymer. These resins are prepared by methods well known in the art.

For example, ABS may be made by one or more of emulsion or solution polymerization processes, bulk/mass, suspension and/or emulsion-suspension process routes. In addition, ABS materials may be produced by other process techniques such as batch, semi batch and continuous polymerization for reasons of either manufacturing economics or product performance or both. In order to reduce point defects or inclusions in the inner layer of the final multi-layer article, the ABS is produced by bulk polymerized.

Emulsion polymerization of vinyl monomers gives rise to a family of addition polymers. In many instances the vinyl emulsion polymers are copolymers containing both rubbery and rigid polymer units. Mixtures of emulsion resins, especially mixtures of rubber and rigid vinyl emulsion derived polymers are useful in blends.

Such rubber modified thermoplastic resins made by an emulsion polymerization process may comprise a discontinuous rubber phase dispersed in a continuous rigid thermoplastic phase, wherein at least a portion of the rigid thermoplastic phase is chemically grafted to the rubber phase. Such a rubbery emulsion polymerized resin may be further blended with a vinyl polymer made by an emulsion or bulk polymerized process. However, at least a portion of the vinyl polymer, rubber or rigid thermoplastic phase, blended with polycarbonate, will be made by emulsion polymerization.

Suitable rubbers for use in making a vinyl emulsion polymer blend are rubbery polymers having a glass transition temperature (Tg) of less than or equal to 25° C., more preferably less than or equal to 0° C., and even more preferably less than or equal to −30° C. As referred to herein, the Tg of a polymer is the Tg value of polymer as measured by differential scanning calorimetry (heating rate 20° C./minute, with the Tg value being determined at the inflection point). In another embodiment, the rubber comprises a linear polymer having structural units derived from one or more conjugated diene monomers. Suitable conjugated diene monomers include, e.g., 1,3-butadiene, isoprene, 1,3-heptadiene, methyl-1,3-pentadiene, 2,3-dimethylbutadiene, 2-ethyl-1,3-pentadiene, 1,3-hexadiene, 2,4-hexadiene, dichlorobutadiene, bromobutadiene and dibromobutadiene as well as mixtures of conjugated diene monomers. In a preferred embodiment, the conjugated diene monomer is 1,3-butadiene.

The emulsion polymer may, optionally, include structural units derived from one or more copolymerizable monoethylenically unsaturated monomers selected from (C₂-C₁₂) olefin monomers, vinyl aromatic monomers and monoethylenically unsaturated nitrile monomers and (C₂-C₁₂) alkyl (meth)acrylate monomers. As used herein, the term “(C₂-C₁₂) olefin monomers” means a compound having from 2 to 12 carbon atoms per molecule and having a single site of ethylenic unsaturation per molecule. Suitable (C₂-C₁₂) olefin monomers include, e.g., ethylene, propene, 1-butene, 1-pentene, heptene, 2-ethyl-hexylene, 2-ethyl-heptene, 1-octene, and 1-nonene. As used herein, the term “(C₁-C₁₂) alkyl” means a straight or branched alkyl substituent group having from 1 to 12 carbon atoms per group and includes, e.g., methyl, ethyl, n-butyl, sec-butyl, t-butyl, n-propyl, iso-propyl, pentyl, hexyl, heptyl, octyl, nonyl, decyl, undecyl and dodecyl, and the terminology “(meth)acrylate monomers” refers collectively to acrylate monomers and methacrylate monomers.

The rubber phase and the rigid thermoplastic phase of the emulsion modified vinyl polymer may, optionally include structural units derived from one or more other copolymerizable monoethylenically unsaturated monomers such as, e.g., monoethylenically unsaturated carboxylic acids such as, e.g., acrylic acid, methacrylic acid, itaconic acid, hydroxy (C₁-C₁₂) alkyl (meth)acrylate monomers such as, e.g., hydroxyethyl methacrylate; (C₅-C₁₂) cycloalkyl (meth)acrylate monomers such as e.g., cyclohexyl methacrylate; (meth)acrylamide monomers such as e.g., acrylamide and methacrylamide; maleimide monomers such as, e.g., N-alkyl maleimides, N-aryl maleimides, maleic anhydride, vinyl esters such as, e.g., vinyl acetate and vinyl propionate. As used herein, the term “(C₅-C₁₂) cycloalkyl” means a cyclic alkyl substituent group having from 5 to 12 carbon atoms per group and the term “(meth)acrylamide” refers collectively to acrylamides and methacrylamides.

In some cases the rubber phase of the emulsion polymer is derived from polymerization of a butadiene, C₄-C₁₂ acrylates or combination thereof with a rigid phase derived from polymerization of styrene, C₁-C₃ acrylates, methacrylates, acrylonitrile or combinations thereof where at least a portion of the rigid phase is grafted to the rubber phase. In other instances more than half of the rigid phase will be grafted to the rubber phase.

Suitable vinyl aromatic monomers include, e.g., styrene and substituted styrenes having one or more alkyl, alkoxyl, hydroxyl or halo substituent group attached to the aromatic ring, including, e.g., -methyl styrene, p-methyl styrene, vinyl toluene, vinyl xylene, trimethyl styrene, butyl styrene, chlorostyrene, dichlorostyrene, bromostyrene, p-hydroxystyrene, methoxystyrene and vinyl-substituted condensed aromatic ring structures, such as, e.g., vinyl naphthalene, vinyl anthracene, as well as mixtures of vinyl aromatic monomers. As used herein, the term “monoethylenically unsaturated nitrile monomer” means an acyclic compound that includes a single nitrile group and a single site of ethylenic unsaturation per molecule and includes, e.g., acrylonitrile, methacrylonitrile, a-chloro acrylonitrile.

In an alternative embodiment, the rubber is a copolymer, preferably a block copolymer, comprising structural units derived from one or more conjugated diene monomers and up to 90 percent by weight (“wt %”) structural units derived from one or more monomers selected from vinyl aromatic monomers and monoethylenically unsaturated nitrile monomers, such as, a styrene-butadiene copolymer, an acrylonitrile-butadiene copolymer or a styrene-butadiene-acrylonitrile copolymer. In another embodiment, the rubber is a styrene-butadiene block copolymer that contains from 50 to 95 wt % structural units derived from butadiene and from 5 to 50 wt % structural units derived from styrene.

The emulsion derived polymers can be further blended with non-emulsion polymerized vinyl polymers, such as those made with bulk or mass polymerization techniques. A process to prepare mixtures containing polycarbonate, an emulsion derived vinyl polymer, along with a bulk polymerized vinyl polymers, is also contemplated.

The rubber phase may be made by aqueous emulsion polymerization in the presence of a radical initiator, a surfactant and, optionally, a chain transfer agent and coagulated to form particles of rubber phase material. Suitable initiators include conventional free radical initiator such as, e.g., an organic peroxide compound, such as e.g., benzoyl peroxide, a persulfate compound, such as, e.g., potassium persulfate, an azonitrile compound such as, e.g., 2,2′-azobis-2,3,3-trimethylbutyronitrile, or a redox initiator system, such as, e.g., a combination of cumene hydroperoxide, ferrous sulfate, tetrasodium pyrophosphate and a reducing sugar or sodium formaldehyde sulfoxylate. Suitable chain transfer agents include, for example, a (C₉-C₁₃) alkyl mercaptan compound such as nonyl mercaptan, t-dodecyl mercaptan. Suitable emulsion aids include, linear or branched carboxylic acid salts, with about 10 to 30 carbon atoms. Suitable salts include ammonium carboxylates and alkaline carboxylates; such as ammonium stearate, methyl ammonium behenate, triethyl ammonium stearate, sodium stearate, sodium iso-stearate, potassium stearate, sodium salts of tallow fatty acids, sodium oleate, sodium palmitate, potassium linoleate, sodium laurate, potassium abieate (rosin acid salt), sodium abietate and combinations thereof. Often mixtures of fatty acid salts derived from natural sources such as seed oils or animal fat (such as tallow fatty acids) are used as emulsifiers.

In various aspects, the emulsion polymerized particles of rubber phase material have a weight average particle size of about 50 to about 800 nanometers (“nm”), as measured by light transmission. In a further aspect, the emulsion polymerized particles of rubber phase material have a weight average particle size of from about 100 to about 500 nm, as measured by light transmission. The size of emulsion polymerized rubber particles may optionally be increased by mechanical, colloidal or chemical agglomeration of the emulsion polymerized particles, according to known techniques.

In a further aspect, acrylonitrile-butadiene-styrene copolymer has an average particle size from about 500 nm to about 1500 nm. In a still further aspect, acrylonitrile-butadiene-styrene copolymer has an average particle size from about 750 nm to about 1250 nm. In a yet further aspect, acrylonitrile-butadiene-styrene copolymer has an average particle size from about 900 nm to about 1100 nm.

The rigid thermoplastic phase comprises one or more vinyl derived thermoplastic polymers and exhibits a Tg of greater than 25° C., preferably greater than or equal to 90° C. and even more preferably greater than or equal to 100° C.

In various aspects, the rigid thermoplastic phase comprises a vinyl aromatic polymer having first structural units derived from one or more vinyl aromatic monomers, preferably styrene, and having second structural units derived from one or more monoethylenically unsaturated nitrile monomers, preferably acrylonitrile. In other cases, the rigid phase comprises from 55 to 99 wt %, still more preferably 60 to 90 wt %, structural units derived from styrene and from 1 to 45 wt %, still more preferably 10 to 40 wt %, structural units derived from acrylonitrile.

The amount of grafting that takes place between the rigid thermoplastic phase and the rubber phase may vary with the relative amount and composition of the rubber phase. In one embodiment, from 10 to 90 wt %, often from 25 to 60 wt %, of the rigid thermoplastic phase is chemically grafted to the rubber phase and from 10 to 90 wt %, preferably from 40 to 75 wt % of the rigid thermoplastic phase remains “free”, i.e., non-grafted.

The rigid thermoplastic phase of the rubber modified thermoplastic resin may be formed solely by emulsion polymerization carried out in the presence of the rubber phase or by addition of one or more separately polymerized rigid thermoplastic polymers to a rigid thermoplastic polymer that has been polymerized in the presence of the rubber phase. In various aspects, the weight average molecular weight of the one or more separately polymerized rigid thermoplastic polymers is from about 50,000 to about 100,000 g/mol. In a further aspect, the weight average molecular weight of the one or more separately polymerized rigid thermoplastic polymers is from about 75,000 to about 150,000 g/mol. In a still further aspect, the weight average molecular weight of the one or more separately polymerized rigid thermoplastic polymers is from about 100,000 to about 135,000 g/mol.

In other cases, the rubber modified thermoplastic resin comprises a rubber phase having a polymer with structural units derived from one or more conjugated diene monomers, and, optionally, further comprising structural units derived from one or more monomers selected from vinyl aromatic monomers and monoethylenically unsaturated nitrile monomers, and the rigid thermoplastic phase comprises a polymer having structural units derived from one or more monomers selected from vinyl aromatic monomers and monoethylenically unsaturated nitrile monomers. In one embodiment, the rubber phase of the rubber modified thermoplastic resin comprises a polybutadiene or poly(styrene-butadiene) rubber and the rigid thermoplastic phase comprises a styrene-acrylonitrile copolymer. Vinyl polymers free of alkyl carbon-halogen linkages, specifically bromine and chlorine carbon bond linkages can provide melt stability.

In some instances it is desirable to isolate the emulsion vinyl polymer or copolymer by coagulation in acid. In such instances the emulsion polymer may be contaminated by residual acid, or species derived from the action of such acid, for example carboxylic acids derived from fatty acid soaps used to form the emulsion. The acid used for coagulation may be a mineral acid; such as sulfuric acid, hydrochloric acid, nitric acid, phosphoric acid or mixtures thereof. In some cases the acid used for coagulation has a pH less than about 5.

In a further aspect, the acrylonitrile-butadiene-styrene copolymer is a bulk polymerized ABS. Bulk polymerized ABS (BABS) (e.g., bulk polymerized ABS graft copolymer) comprises an elastomeric phase comprising one or more unsaturated monomers, such as butadiene having a Tg of less than or equal to 10° C., and a polymeric graft phase (e.g., rigid graft phase) comprising a copolymer of one or more monovinylaromatic monomers such as styrene and one or more unsaturated nitrile monomers, such as acrylonitrile having a Tg greater than 50° C. Rigid generally means a Tg greater than room temperature, e.g., a Tg greater than about 21° C. Such bulk polymerized ABS can be prepared by first providing the elastomeric polymer, then polymerizing the constituent monomers of the rigid graft phase in the presence of the elastomer to obtain the elastomer modified copolymer. As the rigid graft phase copolymer molecular weight increases, a phase inversion occurs in which some of the rigid graft phase copolymer will be entrained within the elastomeric phase. Some of the grafts can be attached as graft branches to the elastomer phase.

In various aspects, the disclosed electromagnetic wave shielding thermoplastic resin compositions comprise a continuous thermoplastic polymer phase, wherein the continuous thermoplastic polymer comprises a the acrylonitrile-butadiene-styrene copolymer, wherein the acrylonitrile-butadiene-styrene copolymer is present in an amount from about 1 wt % to about 20 wt %, wherein the weight percents are based on the total weight of the thermoplastic resin composition. In a further aspect, the acrylonitrile-butadiene-styrene copolymer is present in an amount from about 2 wt % to about 15 wt %. In a still further aspect, the acrylonitrile-butadiene-styrene copolymer is present in an amount from about 2 wt % to about 10 wt %. In a yet further aspect, the acrylonitrile-butadiene-styrene copolymer is present in an amount from about 2 wt % to about 7.5 wt %. In an even further aspect, the acrylonitrile-butadiene-styrene copolymer is present in an amount from about 1 wt % to about 5 wt %. In a still further aspect, the acrylonitrile-butadiene-styrene copolymer is present in an amount from about 2 wt % to about 5 wt %. In a yet further aspect, the acrylonitrile-butadiene-styrene copolymer is present in an amount from about 2 wt % to about 4 wt %.

In a further aspect, the acrylonitrile-butadiene-styrene copolymer comprises from about 10 wt % to about 20 wt % polybutadiene. In a still further aspect, acrylonitrile-butadiene-styrene copolymer comprises from about 12 wt % to about 18 wt % polybutadiene. In a yet further aspect, the acrylonitrile-butadiene-styrene copolymer comprises from about 14 wt % to about 18 wt % polybutadiene.

In a further aspect, the acrylonitrile-butadiene-styrene copolymer comprises from about 50 wt % to about 75 wt % styrene. In a still further aspect, the acrylonitrile-butadiene-styrene copolymer comprises from about 60 wt % to about 75 wt % styrene. In a yet further aspect, the acrylonitrile-butadiene-styrene copolymer comprises from about 65 wt % to about 75 wt % styrene.

In a further aspect, the acrylonitrile-butadiene-styrene copolymer comprises from about 5 wt % to about 25 wt % acrylonitrile. In a still further aspect, the acrylonitrile-butadiene-styrene copolymer comprises from about 10 wt % to about 20 wt % acrylonitrile. In a yet further aspect, the acrylonitrile-butadiene-styrene copolymer comprises from about 12 wt % to about 18 wt % acrylonitrile.

In a further aspect, the acrylonitrile-butadiene-styrene copolymer comprises from about 10 wt % to about 20 wt % polybutadiene; wherein acrylonitrile-butadiene-styrene copolymer comprises from about 50 wt % to about 75 wt % styrene; and wherein acrylonitrile-butadiene-styrene copolymer comprises from about 5 wt % to about 25 wt % acrylonitrile. In a still further aspect, the acrylonitrile-butadiene-styrene copolymer comprises from about 12 wt % to about 18 wt % polybutadiene; wherein acrylonitrile-butadiene-styrene copolymer comprises from about 60 wt % to about 75 wt % styrene; and wherein acrylonitrile-butadiene-styrene copolymer comprises from about 10 wt % to about 20 wt % acrylonitrile. In a yet further aspect, the acrylonitrile-butadiene-styrene copolymer comprises from about 14 wt % to about 18 wt % polybutadiene; wherein acrylonitrile-butadiene-styrene copolymer comprises from about 65 wt % to about 75 wt % styrene; and wherein acrylonitrile-butadiene-styrene copolymer comprises from about 12 wt % to about 18 wt % acrylonitrile.

### High Strength Stainless Steel Fibers

In various aspects, the disclosed blended polycarbonate compositions with improved electromagnetic shielding of the present invention comprise high strength stainless steel fibers, wherein the single fiber strength is greater than or equal to about 20 cN and an elongation of greater than or equal to about 2%.

In a further aspect, the high strength stainless steel fibers are present in the blended polycarbonate composition in an amount from about 5 wt % to about 30 wt %. In a still further aspect, the high strength stainless steel fibers are present in the blended polycarbonate composition in an amount from about 10 wt % to about 25 wt %. In a yet further aspect, the high strength stainless steel fibers are present in the blended polycarbonate composition in an amount from about 12 wt % to about 22 wt %. In an even further aspect, the high strength stainless steel fibers are present in the blended polycarbonate composition in an amount from about 15 wt % to about 20 wt %. In a still further aspect, the high strength stainless steel fibers are present in the blended polycarbonate composition in about 10 wt %, about 11 wt %, about 12 wt %, about 13 wt %, about 14 wt %, about 15 wt %, about 16 wt %, about 17 wt % about 18 wt %, about 19 wt % or about 20 wt %.

In a further aspect, the high strength stainless steel fibers further comprises a polymer coat layer. In a still further aspect, the polymer of the coat layer comprises a polysulfone, a polyester, or both a polysulfone and a polyester. In a yet further aspect, the polymer of the coat layer comprises a polysulfone.

In a further aspect, the high strength stainless steel fiber content is from about 70 wt % to about 85 wt %; and the coat layer content is from about 15 wt % to about 30 wt %. In a still further aspect, the high strength stainless steel fiber content is from about 70 wt % to about 90 wt %; and wherein the coat layer content is from about 10 wt % to about 30 wt %. In a yet further aspect, the high strength stainless steel fiber content is from about 70 wt % to about 80 wt %; and wherein the coat layer content is from about 10 wt % to about 20 wt %.

In a further aspect, the high strength stainless steel fiber content is about 75 wt %; and the coat layer content is about 25 wt %. In a still further aspect, the high strength stainless steel fiber content is about 74 wt %; and the coat layer content is about 26 wt %. In a yet further aspect, the high strength stainless steel fiber content is about 73 wt %; and the coat layer content is about 27 wt %. In an even further aspect, the high strength stainless steel fiber content is about 72 wt %; and the coat layer content is about 28 wt %. In a still further aspect, the high strength stainless steel fiber content is about 71 wt %; and the coat layer content is about 29 wt %. In a yet further aspect, the high strength stainless steel fiber content is about 70 wt %; and the coat layer content is about 30 wt %.

In a further aspect, the high strength stainless steel fiber further comprises a polymeric sizing composition. In a still further aspect, the polymeric sizing composition comprises a polyester. In a yet further aspect, the polyester comprises polybutylene terephthalate (PBT). In an even further aspect, the polyester comprises polyethylene terephthalate (PET).

In a further aspect, the polymeric sizing composition is present in an amount from about 5 wt % to about 20 wt %. In a still further aspect, the polymeric sizing composition is present in an amount from about 5 wt % to about 15 wt %. In a yet further aspect, the polymeric sizing composition is present in an amount from about 7.5 wt % to about 12.5 wt %.

In a further aspect, the high strength stainless steel fiber is present in an amount from about 70 wt % to about 85 wt %; wherein the polymeric sizing composition is present in an amount from about 5 wt % to about 15 wt %; and wherein the coating is present in an amount from about 10 wt % to about 20 wt %.

In a further aspect, the high strength stainless steel fiber has a single fiber strength of greater than or equal to about 21 cN, greater than or equal to about 22 cN, greater than or equal to about 23 cN, greater than or equal to about 24 cN, or greater than or equal to about 25 cN. In a still further aspect, the high strength stainless steel fiber has a single fiber strength of about 20 cN. In a yet further aspect, the high strength stainless steel fiber has a single fiber strength of about 21 cN. In an even further aspect, the high strength stainless steel fiber has a single fiber strength of about 22 cN. In a still further aspect, the high strength stainless steel fiber has a single fiber strength of about 23 cN. In a yet further aspect, the high strength stainless steel fiber has a single fiber strength of about 24 cN. In an even further aspect, the high strength stainless steel fiber has a single fiber strength of about 25 cN.

In a further aspect, the high strength stainless steel fiber has an elongation of greater than or equal to about 2.05%, greater than or equal to about 2.10%, greater than or equal to about 2.15%, greater than or equal to about 2.20%, greater than or equal to about 2.25%, or greater than or equal to about 2.30%. In a still further aspect, the high strength stainless steel fiber has an elongation of about 2.0%. In a yet further aspect, the high strength stainless steel fiber has an elongation of about 2.05%. In an even further aspect, the high strength stainless steel fiber has an elongation of about 2.10%. In a still further aspect, the high strength stainless steel fiber has an elongation of about 2.15%. In a yet further aspect, the high strength stainless steel fiber has an elongation of about 2.20%. In an even further aspect, the high strength stainless steel fiber has an elongation of about 2.25%. In a still further aspect, the high strength stainless steel fiber has an elongation of about 2.30%.

In a further aspect, the high strength stainless steel fiber has a single fiber strength of greater than or equal to about 22 cN and an elongation of greater than or equal to about 2.2%.

In one aspect, stainless steel fibers include those comprising alloys of iron and chromium, nickel, carbon, manganese, molybdenum, mixtures of the foregoing, and the like. The stainless steel fiber is an alloy fiber using iron (Fe) as a base metal and using a significant amount of chrome (Cr) or nickel (Ni) as a main material. Although stainless steel fiber contains iron (Fe) as a main component, it has ferromagneticity at ambient temperature as well as superior corrosion resistance and heat resistance unobtainable from conventional steel, thereby imparting improved electromagnetic wave shielding performance to the electromagnetic wave shielding thermoplastic resin.

In a further aspect, the high strength stainless steel fibers of the present invention have a diameter of about 2 to about 20 micrometers. In a still further aspect, the high strength stainless steel fibers can have a thickness of about 4 to about 25 μM and a length of about 3 to about 15 mm. Accordingly, the stainless steel fibers are uniformly dispersed in the electromagnetic wave shielding thermoplastic resin, thereby ensuring uniformity in electromagnetic wave shielding performance of the electromagnetic wave shielding thermoplastic resin. In a yet further aspect, the high strength stainless steel fibers can have an aspect ratio (the value obtained by dividing the fiber length by the fiber diameter) from about 200 to about 1000. In an even further aspect, the high strength stainless steel fibers have an aspect ratio from about 200 to about 750. In a still further aspect, the high strength stainless steel fibers can be a ferritic or austenitic stainless steel fibers.

In a further aspect, high strength stainless steel tows, sometimes referred to as fiber bundles, can be used. Fiber tows are multiple fiber strands bundled together and coated, or impregnated, with a thin polymer layer. The polymer used for coating the bundle may be the same or different from the thermoplastic polymer of the electromagnetic wave shielding thermoplastic resin composition.

Suitable stainless steel compositions may also be designated according to commonly used grades such as stainless steel 302, 304, 316, 347, and the like. For example stainless steel fibers are commercially available from Bekaert or Huitong. Stainless steel fibers are produced by drawing a bundle of continuous filament fibers from stainless steel through dies.

### Flame Retardants

In one aspect, the electromagnetic wave shielding thermoplastic resin compositions of the present invention can further comprise one or more flame retardants. In a further aspect, at least one flame retardant is a phosphorus-containing flame retardant.

The phosphorous-containing flame retardant useful in the electromagnetic wave shielding thermoplastic resin compositions of the present invention are an organic phosphate and/or an organic compound containing phosphorus-nitrogen bonds. One type of exemplary organic phosphate is an aromatic phosphate of the formula (GO)₃P═O, wherein each G is independently an alkyl, cycloalkyl, aryl, alkaryl, or aralkyl group, provided that at least one G is an aromatic group. Two of the G groups may be joined together to provide a cyclic group, for example, diphenyl pentaerythritol diphosphate, which is described by Axelrod in U.S. Pat. No. 4,154,775. Other suitable aromatic phosphates may be, for example, phenyl bis(dodecyl)phosphate, phenyl bis(neopentyl)phosphate, phenyl bis(3,5,5′-trimethylhexyl)phosphate, ethyl diphenyl phosphate, 2-ethylhexyl di(p-tolyl)phosphate, bis(2-ethylhexyl)p-tolyl phosphate, tritolyl phosphate, bis(2-ethylhexyl)phenyl phosphate, tri(nonylphenyl)phosphate, bis(dodecyl)p-tolyl phosphate, dibutyl phenyl phosphate, 2-chloroethyl diphenyl phosphate, p-tolyl bis(2,5,5′-trimethylhexyl)phosphate, 2-ethylhexyl diphenyl phosphate, or the like. A specific aromatic phosphate is one in which each G is aromatic, for example, triphenyl phosphate, tricresyl phosphate, isopropylated triphenyl phosphate, and the like.

Di- or polyfunctional aromatic phosphorus-containing compounds are also useful, for example, compounds of the formulas below:

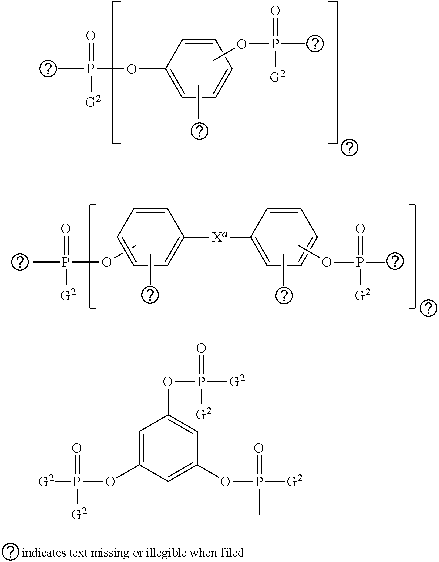

wherein each G¹ is independently a hydrocarbon having 1 to about 30 carbon atoms; each G² is independently a hydrocarbon or hydrocarbonoxy having 1 to about 30 carbon atoms; each X is independently a bromine or chlorine; m 0 to 4, and n is 1 to about 30. Examples of suitable di- or polyfunctional aromatic phosphorus-containing compounds include resorcinol tetraphenyl diphosphate (RDP), the bis(diphenyl)phosphate of hydroquinone and the bis(diphenyl)phosphate of bisphenol-A, respectively, their oligomeric and polymeric counterparts, and the like. Methods for the preparation of the aforementioned di- or polyfunctional aromatic compounds are described in British Patent No. 2,043,083.

In a further aspect, the phosphorus-containing flame retardant is selected from resorcinol bis(biphenyl phosphate), bisphenol A bis(diphenyl phosphate), and hydroquinone bis(diphenyl phosphate), or mixtures thereof. In a still further aspect, the phosphorous-containing flame retardant is bisphenol-A bis(diphenylphosphate). In a yet further aspect, the phosphorus-containing flame retardant is resorcinol bis(biphenyl phosphate).

In a further aspect, the phosphorus-containing flame retardant is present in an amount from about 1 wt % to about 20 wt %. In a still further aspect, the phosphorus-containing flame retardant is present in an amount from about 2 wt % to about 15 wt %. In a yet further aspect, the phosphorus-containing flame retardant is present in an amount from about 4 wt % to about 15 wt %. In an even further aspect, the phosphorus-containing flame retardant is present in an amount from about 5 wt % to about 10 wt %.

In a further aspect, the phosphorous-containing flame retardant does not contain any halogens.

Additional flame retardants may be added as desired. Suitable flame retardants that may be added may be organic compounds that include phosphorus, bromine, and/or chlorine. Non-brominated and non-chlorinated phosphorus-containing flame retardants may be desired in certain applications for regulatory reasons, for example organic phosphates and organic compounds containing phosphorus-nitrogen bonds.

In a further aspect, the flame retardant is selected from a chlorine-containing hydrocarbon, a bromine-containing hydrocarbon, boron compound, a metal oxide, antimony oxide, aluminum hydroxide, a molybdenum compound, zinc oxide, magnesium oxide, an organic phosphate, phospinate, phosphite, phosphonate, phosphene, halogenated phosphorus compound, inorganic phosphorus containing salt, and a nitrogen-containing compound, or a combination comprising at least one of the foregoing.

In a further aspect, examples of flame retardants include, but are not limited to, halogenated flame retardants, like tetrabromo bisphenol A oligomers such as BC58 and BC52, brominated polystyrene or poly(dibromo-styrene), brominated epoxies, pentabromobenzyl acrylate polymer, ethylene-bis(tetrabromophthalimide, bis(pentabromobenzyl)ethane, Al(OH)₃, phosphor based FR systems like red phosphorus, metal phosphinates, expandable graphites, sodium or potassium perfluorobutane sulfate, sodium or potassium perfluorooctane sulfate, sodium or potassium diphenylsulfone sulfonate and sodium- or potassium-2,4,6-trichlorobenzoate, or a combination containing at least one of the foregoing.

In a further aspect, examples of flame retardants include, but are not limited to, 2,2-bis-(3,5-dichlorophenyl)-propane; bis-(2-chlorophenyl)-methane; bis(2,6-dibromophenyl)-methane; 1,1-bis-(4-iodophenyl)-ethane; 1,2-bis-(2,6-dichlorophenyl)-ethane; 1,1-bis-(2-chloro-4-iodophenyl)ethane; 1,1-bis-(2-chloro-4-methylphenyl)-ethane; 1,1-bis-(3,5-dichlorophenyl)-ethane; 2,2-bis-(3-phenyl-4-bromophenyl)-ethane; 2,6-bis-(4,6-dichloronaphthyl)-propane; 2,2-bis-(2,6-dichlorophenyl)-pentane; 2,2-bis-(3,5-dibromophenyl)-hexane; bis-(4-chlorophenyl)-phenyl-methane; bis-(3,5-dichlorophenyl)-cyclohexylmethane; bis-(3-nitro-4-bromophenyl)-methane; bis-(4-hydroxy-2,6-dichloro-3-methoxyphenyl)-methane; and 2,2-bis-(3,5-dichloro-4-hydroxyphenyl)-propane 2,2bis-(3-bromo-4-hydroxyphenyl)-propane. Also included within the above structural formula are: 1,3-dichlorobenzene, 1,4-dibromobenzene, 1,3-dichloro-4-hydroxybenzene, and biphenyls such as 2,2′-dichlorobiphenyl, polybrominated 1,4-diphenoxybenzene, 2,4′-dibromobiphenyl, and 2,4′-dichlorobiphenyl as well as decabromo diphenyl oxide, and the like.

Also useful are oligomeric and polymeric halogenated aromatic compounds, such as a copolycarbonate of bisphenol A and tetrabromobisphenol A and a carbonate precursor, e.g., phosgene. Metal synergists, e.g., antimony oxide, may also be used with the flame retardant.

Inorganic flame retardants may also be used, for example salts of C₁₋₁₆ alkyl sulfonate salts such as potassium perfluorobutane sulfonate (Rimar salt), potassium perfluoroctane sulfonate, tetraethylammonium perfluorohexane sulfonate, and potassium diphenylsulfone sulfonate, and the like; salts formed by reacting for example an alkali metal or alkaline earth metal (for example lithium, sodium, potassium, magnesium, calcium and barium salts) and an inorganic acid complex salt, for example, an oxo-anion, such as alkali metal and alkaline-earth metal salts of carbonic acid, such as Na₂CO₃, K₂CO₃, MgCO₃, CaCO₃, and BaCO₃ or a fluoro-anion complex such as Li₃AIF₆, BaSiF₆, KBF₄, K₃AIF₆, KAIF₄, K₂SiF₆, and/or Na₃AIF₆ or the like.

In a further aspect, at least one flame retardant is an inorganic flame retardant. In a still further aspect, the inorganic flame retardant is a smoke suppressant. In a yet further aspect, the inorganic flame retardant is selected from alumina trihydroxide, magnesium hydroxide, antimony oxide, and zinc borate. In an even further aspect, the inorganic flame retardant is zinc borate.

In a further aspect, the inorganic flame retardant is present in an amount from about 0.1 wt % to about 5 wt %. In a still further aspect, the inorganic flame retardant is present in an amount from about 0.1 wt % to about 2 wt %. In a yet further aspect, the inorganic flame retardant is present in an amount from about 0.1 wt % to about 1.5 wt %.

Related to flame retardants are smoke suppressants (or alternatively referred to as smoke suppression agents). In various aspects, the disclosed electromagnetic wave shielding thermoplastic resin compositions can further comprise a smoke suppression agent. Such smoke suppression agents are known in the art to include molybdenum oxides, including MoO₃, ammonium octamolybdate (AOM), calcium and zinc molybdates; iron, copper, manganese, cobalt or vanadyl phthalocyanines, which may be used as a synergist with octabromobiphenyl; ferrocenes (organometallic iron), which may be used in combination with Cl paraffin and/or antimony oxide; hydrated Iron (III) oxide; hydrated zinc borates; zinc stannate and zinc hydroxy stannate; hydrates, carbonates and borates; alumina trihydrate (ATH); magnesium hydroxide; metal halides of iron, zinc, titanium, copper, nickel, cobalt, tin, aluminum, antimony and cadmium, which are non-hydrous and non-ionic, and which may be used with complexing agents such as quaternary ammonium compounds, quaternary phosphonium compounds, tertiary sulfonium compounds, organic orthosilicates, the partially hydrolyzed derivatives of organic orthosilicates, or a combination including one or more of them; nitrogen compounds, including ammonium polyphosphates (monammonium phosphate, diammonium phosphate, and the like); and FeOOH. Such smoke suppression agents may be used singly or in combination, optionally in amounts of about 0.1 to about 20 wt. % of the composition or by weight of the polymer resins in the composition or, in some cases, about 1 to about 5 wt. % by weight of the composition or by weight of the polymer resins. In some embodiments, a smoke suppression agent may be used to the exclusion of a polyetherimide.

### Polymer Additives

In one aspect, the electromagnetic wave shielding thermoplastic resin compositions of the present invention can further comprise various additives ordinarily incorporated in resin compositions of this type, with the proviso that the additives are selected so as to not significantly adversely affect the desired properties of the thermoplastic composition. Combinations of additives can be used. Such additives can be mixed at a suitable time during the mixing of the components for forming the composition.

The compositions of the invention can also be combined with various additives including, but not limited to, colorants such as titanium dioxide, zinc sulfide and carbon black; stabilizers or antioxidants such as hindered phenols, phosphites, phosphonites, thioesters and mixtures thereof, as well as mold release agents, lubricants, flame retardants, smoke suppressors and anti-drip agents, for example, those based on fluoropolymers.

In other aspects, the inventive polycarbonate can comprise one or more other materials, i.e. polymer additives, which can maintain and/or improve various properties of the resulting material. The additive may include, but are not limited to, fillers, antioxidants, lubricants, flame retardants, nucleating agents, coupling agents, ultraviolet absorbers, ultraviolet stabilizers, pigments, dyes, plasticizers, processing aids, viscosity control agents, tackifiers, anti-blocking agents, surfactants, extender oils, metal deactivators, voltage stabilizers, boosters, catalysts, smoke suppressants and the like, or a combination containing at least one of the foregoing, depending on the final selected characteristics of the compositions. Examples of additives, fillers and the like that may be used in the present invention include, but are not limited to, antioxidants, mineral fillers, and the like, or a combination containing at least one of the foregoing.

In various aspects, the continuous thermoplastic polymer phase further comprises at least one polymer additive selected from an antioxidant, heat stabilizer, light stabilizer, ultraviolet light absorber, plasticizer, mold release agent, lubricant, antistatic agent, pigment, dye, and gamma stabilizer. In a further aspect, the continuous thermoplastic polymer phase further comprises at least one polymer additive selected from a flame retardant, a colorant, a primary anti-oxidant, and a secondary anti-oxidant.

The electromagnetic wave shielding thermoplastic resin compositions of the invention can also be combined with various additives including, but not limited to, colorants such as titanium dioxide, zinc sulfide and carbon black; stabilizers such as hindered phenols, phosphites, phosphonites, thioesters and mixtures thereof, as well as mold release agents, lubricants, flame retardants, smoke suppressors and anti-drip agents, for example, those based on fluoro polymers. In various aspects, the polymer composition additive comprises one or more of a colorant, anti-oxidant, mold release agent, lubricant, flame retardant agent, smoke suppressor agent, and anti-drip agent. Effective amounts of the additives vary widely, but they are usually present in an amount up to about 0.01-20% or more by weight, based on the weight of the entire composition.

In a further aspect, a mold release agent useful in the present invention can be an alkyl carboxylic acid esters, for example, pentaerythritol tetrastearate, glycerin tristearate and ethylene glycol distearate. Mold release agents are typically present in the composition at 0.01-0.5% by weight of the formulation. Other examples of mold release agents are may also be alpha-olefins or low molecular weight poly alpha olefins, or blends thereof.

In a further aspect, the electromagnetic wave shielding thermoplastic resin composition further comprises an antioxidant in an amount from about 0.001 wt % to about 0.500 wt %. In a yet further aspect, the antioxidant is selected from hindered phenols, phosphites, phosphonites, thioesters and any mixture thereof. Examples of antioxidants include, but are not limited to, hindered phenols such tetrakis[methylene(3,5-di-t-butyl-4-hydroxyhydrocinnamate)]-methane, 4,4′-thiobis(2-methyl-6-tert-butylphenol), and thiodiethylene bis(3,5-di-tert-butyl-4-hydroxy)hydrocinnamate, octadecyl-3(3.5-di-tert.butyl-4-hydroxyphenyl)propionate, pentaerythritoltetrakis(3(3.5-di-tert.butyl-4-hydroxyphenyl)propionate), phosphites and phosphonites such as tris(2,4-di-tert-butylphenyl)phosphite and thio compounds such as dilauryl thiodipropionate, dimyristyl thiodipropionate, and distearyl thiodipropionate, potassium iodide, cuprous iodide, various siloxanes, and amines such as polymerized 2,2,4-trimethyl-1,2-dihydroquinoline and the like, or a combination containing at least one of the foregoing.

In various further aspects, exemplary antioxidant additives include, for example, organophosphites such as tris(nonyl phenyl)phosphite, tris(2,4-di-t-butylphenyl)phosphite (e.g., “IRGAFOS 168” or “I-168”), bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants. In a further aspect, antioxidants can be present in amounts of 0.0001 to 1 wt % of the overall polycarbonate composition.

In various aspects, the continuous thermoplastic polymer phase further comprises a primary anti-oxidant. In various further aspects, the primary anti-oxidant is selected from a hindered phenol and secondary aryl amine, or a combination thereof. In a further aspect, the hindered phenol comprises one or more compounds selected from triethylene glycol bis[3-(3-t-butyl-5-methyl-4-hydroxyphenyl)propionate], 1,6-hexanediolbis[3-(3,5-di-t-butyl-4-hydroxyphenyl)propionate], 2,4-bis(n-octylthio)-6-(4-hydroxy-3,5-di-t-butylanilino)-1,3,5-triazine, pentaerythrityl tetrakis[3-(3,5-di-t-butyl-4-hydroxyphenyl)propionate], 2,2-thiodiethylene bis[3-(3,5-di-t-butyl-4-hydroxyphenyl)propionate], octadecyl 3-(3,5-di-t-butyl-4-hydroxyphenyl)propionate, N,N′-hexamethylene bis(3,5-di-t-butyl-4-hydroxy-hydrocinnamamide), tetrakis(methylene 3,5-di-tert-butyl-hydroxycinnamate)methane, and octadecyl 3,5-di-tert-butylhydroxyhydrocinnamate. In a still further aspect, the hindered phenol comprises octadecyl-3-(3,5-di-t-butyl-4-hydroxyphenyl)-propionate.

In a further aspect, the primary anti-oxidant is present in an amount from about 0.01 wt % to about 0.50 wt %. In a still further aspect, the primary anti-oxidant is present in an amount from about 0.01 wt % to about 0.20 wt %. In a yet further aspect, the primary anti-oxidant is present in an amount from about 0.01 wt % to about 0.10 wt %. In an even further aspect, the primary anti-oxidant is present in an amount from about 0.02 wt % to about 0.08 wt %. In a still further aspect, the primary anti-oxidant is present in an amount from about 0.03 wt % to about 0.07 wt %.

In various aspects, the continuous thermoplastic polymer phase further comprises a secondary anti-oxidant. In various further aspects, the secondary anti-oxidant is selected from an organophosphate and thioester, or a combination thereof. In a further aspect, the secondary anti-oxidant comprises one or more compounds selected from tetrakis(2,4-di-tert-butylphenyl) [1,1-biphenyl]-4,4′-diylbisphosphonite, tris(2,4-di-tert-butylphenyl) phosphite, bis(2,4-di-tert-butylphenyl) pentaerythritol diphosphite, bis(2,4-dicumylphenyl)pentaerytritoldiphosphite, tris(nonyl phenyl)phosphite, and distearyl pentaerythritol diphosphite. In a still further aspect, the secondary anti-oxidant comprises tris(2,4-di-tert-butylphenyl) phosphite.

In a further aspect, the secondary anti-oxidant is present in an amount from about 0.01 wt % to about 0.50 wt %. In a still further aspect, the secondary anti-oxidant is present in an amount from about 0.01 wt % to about 0.20 wt %. In a yet further aspect, the secondary anti-oxidant is present in an amount from about 0.01 wt % to about 0.10 wt %. In an even further aspect, the secondary anti-oxidant is present in an amount from about 0.02 wt % to about 0.08 wt %. In a still further aspect, the secondary anti-oxidant is present in an amount from about 0.03 wt % to about 0.07 wt %.

Exemplary heat stabilizer additives include, for example, organophosphites such as triphenyl phosphite, tris-(2,6-dimethylphenyl)phosphite, tris-(mixed mono- and di-nonylphenyl)phosphite or the like; phosphonates such as dimethylbenzene phosphonate or the like, phosphates such as trimethyl phosphate, or the like, or combinations comprising at least one of the foregoing heat stabilizers. Heat stabilizers are generally used in amounts of 0.0001 to 1 wt % of the overall polycarbonate composition.

Light stabilizers and/or ultraviolet light (UV) absorbing additives can also be used. Exemplary light stabilizer additives include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone, or the like, or combinations comprising at least one of the foregoing light stabilizers. Light stabilizers are generally used in amounts of 0.0001 to 1 wt % of the overall polycarbonate composition.

Exemplary UV absorbing additives include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB® 5411); 2-hydroxy-4-n-octyloxybenzophenone (CYASORB® 531); 2-[4,6-bis(2,4-dimethylphenyl)-1,3,5-triazin-2-yl]-5-(octyloxy)-phenol (CYASORB® 1164); 2,2′-(1,4-phenylene)bis(4H-3,1-benzoxazin-4-one) (CYASORB® UV-3638); 1,3-bis[(2-cyano-3,3-diphenylacryloyl)oxy]-2,2-bis[[(2-cyano-3,3-diphenylacryloyl)oxy]methyl]propane (UVINUL® 3030); 2,2′-(1,4-phenylene)bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; nano-size inorganic materials such as titanium oxide, cerium oxide, and zinc oxide, all with particle size less than or equal to 100 nanometers; or the like, or combinations comprising at least one of the foregoing UV absorbers. UV absorbers are generally used in amounts of 0.0001 to 1 wt % of the overall polycarbonate composition.

Plasticizers, lubricants, and/or mold release agents can also be used. There is considerable overlap among these types of materials, which include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl) phosphate of hydroquinone and the bis(diphenyl) phosphate of bisphenol-A; poly-alpha-olefins; epoxidized soybean oil; silicones, including silicone oils; esters, for example, fatty acid esters such as alkyl stearyl esters, e.g., methyl stearate, stearyl stearate, pentaerythritol tetrastearate (PETS), and the like; combinations of methyl stearate and hydrophilic and hydrophobic nonionic surfactants comprising polyethylene glycol polymers, polypropylene glycol polymers, poly(ethylene glycol-co-propylene glycol) copolymers, or a combination comprising at least one of the foregoing glycol polymers, e.g., methyl stearate and polyethylene-polypropylene glycol copolymer in a suitable solvent; waxes such as beeswax, montan wax, paraffin wax, or the like. Such materials are generally used in amounts of 0.001 to 1 wt %, specifically 0.01 to 0.75 wt %, more specifically 0.1 to 0.5 wt % of the overall polycarbonate composition.

In a further aspect, the electromagnetic wave shielding thermoplastic resin composition further can further comprise an anti-static agent. The term “anti-static agent” refers to monomeric, oligomeric, or polymeric materials that can be processed into polymer resins and/or sprayed onto materials or articles to improve conductive properties and overall physical performance. Examples of monomeric anti-static agents include glycerol monostearate, glycerol distearate, glycerol tristearate, ethoxylated amines, primary, secondary and tertiary amines, ethoxylated alcohols, alkyl sulfates, alkylarylsulfates, alkylphosphates, alkylaminesulfates, alkyl sulfonate salts such as sodium stearyl sulfonate, sodium dodecylbenzenesulfonate or the like, quaternary ammonium salts, quaternary ammonium resins, imidazoline derivatives, sorbitan esters, ethanolamides, betaines, or the like, or combinations comprising at least one of the foregoing monomeric anti-static agents.

Exemplary polymeric antistatic agents include certain polyesteramides, polyether-polyamide (polyetheramide) block copolymers, polyetheresteramide block copolymers, polyetheresters, or polyurethanes, each containing polyalkylene glycol moieties such as polyethylene glycol, polypropylene glycol, polytetramethylene glycol, and the like. Such polymeric antistatic agents are commercially available, such as, for example, Pelestat™ 6321 (Sanyo), Pebax™ MH1657 (Atofina), and Irgastat™ P18 and P22 (Ciba-Geigy). Other polymeric materials that may be used as antistatic agents are inherently conducting polymers such as polyaniline (commercially available as PANIPOL®EB from Panipol), polypyrrole and polythiophene (commercially available from Bayer), which retain some of their intrinsic conductivity after melt processing at elevated temperatures. In one embodiment, carbon fibers, carbon nanofibers, carbon nanotubes, carbon black, or any combination of the foregoing may be used in a polymeric resin containing chemical antistatic agents to render the composition electrostatically dissipative. Antistatic agents are generally used in amounts of about 0.1 to about 10 parts by weight of the electromagnetic wave shielding thermoplastic resin composition.

Anti-drip agents may also be included in the composition, and include, for example fluoropolymers, such as a fibril forming or non-fibril forming fluoropolymer such as fibril forming polytetrafluoroethylene (PTFE) or non-fibril forming polytetrafluoroethylene, or the like; encapsulated fluoropolymers, i.e., a fluoropolymer encapsulated in a polymer as the anti-drip agent, such as a styrene-acrylonitrile copolymer encapsulated PTFE (TSAN) or the like, or combinations including at least one of the foregoing anti-drip agents. An encapsulated fluoropolymer may be made by polymerizing the polymer in the presence of the fluoropolymer. TSAN may be made by copolymerizing styrene and acrylonitrile in the presence of an aqueous dispersion of PTFE. TSAN may provide significant advantages over PTFE, in that TSAN may be more readily dispersed in the composition. TSAN may, for example, include 50 wt. % PTFE and 50 wt. % styrene-acrylonitrile copolymer, based on the total weight of the encapsulated fluoropolymer. The styrene-acrylonitrile copolymer may, for example, be 75 wt. % styrene and 25 wt. % acrylonitrile based on the total weight of the copolymer. Alternatively, the fluoropolymer may be pre-blended in some manner with a second polymer, such as for, example, an aromatic polycarbonate resin or a styrene-acrylonitrile resin as in, for example, U.S. Pat. Nos. 5,521,230 and 4,579,906 to form an agglomerated material for use as an anti-drip agent. Either method may be used to produce an encapsulated fluoropolymer. Anti-drip agents are generally used in amounts of from 0.1 to 1.4 parts by weight, based on 100 parts by weight of based on 100 parts by weight of the total composition, exclusive of any filler.

In various aspects, the continuous thermoplastic polymer phase further comprises an anti-drip agent. In a further aspect, the anti-drip agent is present in an amount from about 0.1 wt % to about 5 wt %. In a still further aspect, the anti-drip agent is present in an amount from about 0.1 wt % to about 2 wt %. In a yet further aspect, the anti-drip agent is present in an amount from about 0.1 wt % to about 1 wt %. In an even further aspect, the anti-drip agent is styrene-acrylonitrile copolymer encapsulated PTFE (TSAN).

Where a foam is desired, suitable blowing agents include, for example, low boiling halohydrocarbons and those that generate carbon dioxide; blowing agents that are solid at room temperature and when heated to temperatures higher than their decomposition temperature, generate gases such as nitrogen, carbon dioxide or ammonia gas, such as azodicarbonamide, metal salts of azodicarbonamide, 4,4′ oxybis(benzenesulfonylhydrazide), sodium bicarbonate, ammonium carbonate, or the like; or combinations comprising at least one of the foregoing blowing agents.

In a further aspect, the electromagnetic wave shielding thermoplastic resin compositions further can further comprise a colorant in an amount from about 0.001 pph to about 5.000 pph. In a still further aspect, the colorant is selected from the group consisting of carbon black and titanium dioxide. In a yet further aspect, the colorant is carbon black. In an even further aspect, the colorant is titanium dioxide. In a still further aspect, the titanium dioxide is encapsulated with a silica alumino layer which is passivated with a silicon containing compound. The titanium dioxide can be passivated by treatment with silica and/or alumina by any of several methods which are well known in the art including, without limit, silica and/or alumina wet treatments used for treating pigment-sized titanium dioxide.

Besides the titanium dioxide, other colorants such as pigment and/or dye additives can also be present in order to offset any color that can be present in the polycarbonate resin and to provide desired color to the customer. Useful pigments can include, for example, inorganic pigments such as metal oxides and mixed metal oxides such as zinc oxide, iron oxides, or the like; sulfides such as zinc sulfides, or the like; aluminates; sodium sulfo-silicates sulfates, chromates, or the like; carbon blacks; zinc ferrites; ultramarine blue; organic pigments such as azos, di-azos, quinacridones, perylenes, naphthalene tetracarboxylic acids, flavanthrones, isoindolinones, tetrachloroisoindolinones, anthraquinones, enthrones, dioxazines, phthalocyanines, and azo lakes; Pigment Red 101, Pigment Red 122, Pigment Red 149, Pigment Red 177, Pigment Red 179, Pigment Red 202, Pigment Violet 29, Pigment Blue 15, Pigment Blue 60, Pigment Green 7, Pigment Yellow 119, Pigment Yellow 147, Pigment Yellow 150, and Pigment Brown 24; or combinations comprising at least one of the foregoing pigments. Pigments are generally used in amounts of 0.01 to 10 wt % of the overall polycarbonate composition.

Exemplary dyes are generally organic materials and include, for example, coumarin dyes such as coumarin 460 (blue), coumarin 6 (green), nile red or the like; lanthanide complexes; hydrocarbon and substituted hydrocarbon dyes; polycyclic aromatic hydrocarbon dyes; scintillation dyes such as oxazole or oxadiazole dyes; aryl- or heteroaryl-substituted poly (C2-8) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; naphthalimide dyes; lactone dyes; fluorophores such as anti-stokes shift dyes which absorb in the near infrared wavelength and emit in the visible wavelength, or the like; luminescent dyes such as 7-amino-4-methylcoumarin; 3-(2′-benzothiazolyl)-7-diethylaminocoumarin; 2-(4-biphenylyl)-5-(4-t-butylphenyl)-1,3,4-oxadiazole; 2,5-bis-(4-biphenylyl)-oxazole; 2,2′-dimethyl-p-quaterphenyl; 2,2-dimethyl-p-terphenyl; 3,5,3″″,5″″-tetra-t-butyl-p-quinquephenyl; 2,5-diphenylfuran; 2,5-diphenyloxazole; 4,4′-diphenylstilbene; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-dimethylamino-1-methyl-4-methoxy-8-azaquinolone-2; 7-dimethylamino-4-methylquinolone-2; 2-(4-(4-dimethylaminophenyl)-1,3-butadienyl)-3-ethylbenzothiazolium perchlorate; 3-diethylamino-7-diethyliminophenoxazonium perchlorate; 2-(1-naphthyl)-5-phenyloxazole; 2,2′-p-phenylen-bis(5-phenyloxazole); rhodamine 700; rhodamine 800; pyrene, chrysene, rubrene, coronene, or the like; or combinations comprising at least one of the foregoing dyes. Dyes are generally used in amounts of 0.01 to 10 wt % of the overall polycarbonate composition.

Radiation stabilizers can also be present, specifically gamma-radiation stabilizers. Exemplary gamma-radiation stabilizers include alkylene polyols such as ethylene glycol, propylene glycol, 1,3-propanediol, 1,2-butanediol, 1,4-butanediol, meso-2,3-butanediol, 1,2-pentanediol, 2,3-pentanediol, 1,4-pentanediol, 1,4-hexandiol, and the like; cycloalkylene polyols such as 1,2-cyclopentanediol, 1,2-cyclohexanediol, and the like; branched alkylenepolyols such as 2,3-dimethyl-2,3-butanediol (pinacol), and the like, as well as alkoxy-substituted cyclic or acyclic alkanes. Unsaturated alkenols are also useful, examples of which include 4-methyl-4-penten-2-ol, 3-methyl-pentene-3-ol, 2-methyl-4-penten-2-ol, 2,4-dimethyl-4-pene-2-ol, and 9 to decen-1-ol, as well as tertiary alcohols that have at least one hydroxy substituted tertiary carbon, for example 2-methyl-2,4-pentanediol (hexylene glycol), 2-phenyl-2-butanol, 3-hydroxy-3-methyl-2-butanone, 2-phenyl-2-butanol, and the like, and cyclic tertiary alcohols such as 1-hydroxy-1-methyl-cyclohexane. Certain hydroxymethyl aromatic compounds that have hydroxy substitution on a saturated carbon attached to an unsaturated carbon in an aromatic ring can also be used. The hydroxy-substituted saturated carbon can be a methylol group (—CH₂OH) or it can be a member of a more complex hydrocarbon group such as —CR⁴HOH or —CR⁴OH wherein R⁴ is a complex or a simple hydrocarbon. Specific hydroxy methyl aromatic compounds include benzhydrol, 1,3-benzenedimethanol, benzyl alcohol, 4-benzyloxy benzyl alcohol and benzyl benzyl alcohol. 2-Methyl-2,4-pentanediol, polyethylene glycol, and polypropylene glycol are often used for gamma-radiation stabilization. Gamma-radiation stabilizing compounds are typically used in amounts of 0.1 to 10 wt % of the overall polycarbonate composition.

In another aspect, the inventive polycarbonate composition can comprise a filler, such as, for example, an inorganic filler or reinforcing agent. The specific composition of a filler, if present, can vary, provided that the filler is chemically compatible with the remaining components of the polycarbonate composition. In one aspect, the polycarbonate composition comprises a filler, such as, for example, talc. If present, the amount of filler can comprise any amount suitable for a polycarbonate composition that does not adversely affect the desired properties thereof. In one aspect, the inventive polycarbonate comprises about 1 wt. % to about 10 wt. % of a filler.

In another aspect, a filler can comprise silicates and silica powders such as aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, or the like; calcium sulfate (as its anhydride, dihydrate or trihydrate), or the like; talc, including fibrous, modular, needle shaped, lamellar talc, or the like; wollastonite; surface-treated wollastonite; glass spheres such as hollow and solid glass spheres, silicate spheres, aluminosilicate, or the like; kaolin, including hard kaolin, soft kaolin, calcined kaolin, kaolin comprising various coatings known in the art to facilitate compatibility with the polymeric matrix resin, or the like; single crystal fibers or “whiskers” such as silicon carbide, alumina, boron carbide, iron, nickel, copper, or the like; fibers (including continuous and chopped fibers), carbon fibers, glass fibers, such as E, A, C, ECR, R, S, D, or NE glasses, or the like; sulfides such as molybdenum sulfide, zinc sulfide or the like; barium compounds such as barium titanate, barium ferrite, barium sulfate, heavy spar, or the like; metals and metal oxides such as particulate or fibrous aluminum, bronze, zinc, copper and nickel or the like; flaked fillers such as glass flakes, flaked silicon carbide, aluminum diboride, aluminum flakes, steel flakes or the like; fibrous fillers, for example short inorganic fibers such as those derived from blends comprising at least one of aluminum silicates, aluminum oxides, magnesium oxides, and calcium sulfate hemihydrate or the like; natural fillers and reinforcements, such as wood flour obtained by pulverizing wood, fibrous products such as cellulose, cotton, or the like; organic fillers such as polytetrafluoroethylene; reinforcing organic fibrous fillers formed from organic polymers capable of forming fibers such as poly(ether ketone), polyimide, polybenzoxazole, poly(phenylene sulfide), aromatic polyamides, aromatic polyimides, polyetherimides, polytetrafluoroethylene, or the like; as well as additional fillers and reinforcing agents such as mica, clay, feldspar, flue dust, fillite, quartz, quartzite, perlite, tripoli, diatomaceous earth, carbon black, or the like, or combinations comprising at least one of the foregoing fillers or reinforcing agents.

In one aspect, a filler, if present, can be coated with a layer of metallic material to facilitate conductivity, or surface treated with silanes to improve adhesion and dispersion with the polymeric matrix resin. In addition, the reinforcing fillers can be provided in the form of monofilament or multifilament fibers and can be used individually or in combination with other types of fiber, through, for example, co-weaving or core/sheath, side-by-side, orange-type or matrix and fibril constructions, or by other methods known to one skilled in the art of fiber manufacture. Exemplary co-woven structures include, for example, glass fiber-carbon fiber, carbon fiber-aromatic polyimide (aramid) fiber, and aromatic polyimide fiberglass fiber or the like. Fibrous fillers can be supplied in the form of, for example, rovings, woven fibrous reinforcements, such as 0-90 degree fabrics or the like; non-woven fibrous reinforcements such as continuous strand mat, chopped strand mat, tissues, papers and felts or the like; or three-dimensional reinforcements such as braids.

### Manufacture of Blended Polycarbonate Compositions

In various aspects, the electromagnetic wave shielding thermoplastic resin compositions of the present invention can be manufactured by various methods. The compositions of the present invention can be blended by a variety of methods involving intimate admixing of the materials with any additional additives desired in the formulation. Because of the availability of melt blending equipment in commercial polymer processing facilities, melt processing methods can be used. In various further aspects, the equipment used in such melt processing methods includes, but is not limited to, the following: co-rotating and counter-rotating extruders, single screw extruders, co-kneaders, disc-pack processors and various other types of extrusion equipment. In a further aspect, the extruder is a twin-screw extruder. In various further aspects, the melt processed composition exits processing equipment such as an extruder through small exit holes in a die. The resulting strands of molten resin are cooled by passing the strands through a water bath. The cooled strands can be chopped into small pellets for packaging and further handling.

In a further aspect, the electromagnetic wave shielding thermoplastic resin compositions of the present invention can be by any suitable mixing means known in the art, for example dry blending the polycarbonate-acrylonitrile butadiene polymer blend, the high strength stainless steel fibers and the glass fibers, and subsequently melt mixing, either directly in the melt blending apparatus, e.g., an injection molding machine or an extruder, to make the electrically conductive thermoplastic structure of the present invention (e.g., an injection molded article or an extruded sheet or profile), or pre-mixing in a separate extruder (e.g., a Banbury mixer) to produce pellets. Said pellets can then be injection molded or extruded into sheet or profile to produce the electrically conductive thermoplastic structure of the present invention.

In various aspects, dry blends of the compositions are directly injection molded or directly extruded into sheet or profile without pre-melt mixing and melt blending to form pellets. The polycarbonate-acrylonitrile butadiene polymer blend, the high strength stainless steel fibers and the glass fibers can be introduced into the melt blending apparatus simultaneously in the same location (e.g., feed hopper), individually in different locations (e.g., feed hopper and one or more side feed locations), or in any combination. This process allows for the flexibility of increasing or decreasing the amount of high strength stainless steel fiber and/or increasing or decreasing the amount of glass fiber and/or polycarbonate-acrylonitrile butadiene polymer blend of the electromagnetic wave shielding thermoplastic resin composition online. That is, different balance of electromagnetic wave shielding effectiveness and other properties can be tailored and produced for a specific electrically conductive thermoplastic structure with little effort and minimal inventory of polymers and fibers versus using pre-mixed electrically conductive thermoplastic polymer compositions in the form of pellets.

The temperature of the melt is minimized in order to avoid excessive degradation of the resins. For example, it can be desirable to maintain the melt temperature between about 230° C. and about 350° C. in the molten resin composition, although higher temperatures can be used provided that the residence time of the resin in the processing equipment is kept short. In a still further aspect, the extruder is typically operated at a temperature of about 180° C. to about 385° C. In a yet further aspect, the extruder is typically operated at a temperature of about 200° C. to about 330° C. In an even further aspect, the extruder is typically operated at a temperature of about 220° C. to about 300° C.

In various aspects, the electromagnetic wave shielding thermoplastic resin compositions of the present invention can be prepared by blending the blend of a polycarbonate and an acrylonitrile butadiene styrene polymer, high strength steel fibers, and glass fibers in a mixer, e.g. a HENSCHEL-Mixer® high speed mixer or other suitable mixer/blender. Other low shear processes, including but not limited to hand mixing, can also accomplish this blending. The mixture can then be fed into the throat of a single or twin screw extruder via a hopper. Alternatively, at least one of the components can be incorporated into the composition by feeding directly into the extruder at the throat and/or downstream through a sidestuffer. Additives can also be compounded into a masterbatch desired polymeric resin and fed into the extruder. The extruder generally operated at a temperature higher than that necessary to cause the composition to flow. The extrudate is immediately quenched in a water bath and pelletized. The pellets, so prepared, when cutting the extrudate can be one-fourth inch long or less as desired. Such pellets can be used for subsequent molding, shaping, or forming.

In a further aspect, a method of manufacturing an article comprises melt blending the blend of a polycarbonate and an acrylonitrile butadiene styrene polymer, high strength stainless steel fibers, and glass fibers; and molding the extruded composition into an article. In a still further aspect, the extruding is done with a single screw extruder or a twin screw extruder.

In a further aspect, the invention pertains to methods of preparing a electromagnetic wave shielding thermoplastic resin compositions comprises blending a) from about 30 wt % to about 75 wt % of a blend of a polycarbonate and an acrylonitrile butadiene styrene polymer; b) from about 5 wt % to about 30 wt % high strength stainless steel fibers; and c) from about 0 wt % to about 30 wt % glass fibers; wherein the high strength stainless steel fibers have a single fiber strength of greater than or equal to about 20 cN and an elongation of greater than or equal to about 2%; and wherein the composition exhibits electromagnetic wave shielding performance at least about 60 dB when determined on a 1.2 mm thick sample.

In a further aspect, the invention pertains to methods of preparing a composition, comprising: blending a) from about 30 wt % to about 75 wt % of a blend of a polycarbonate and an acrylonitrile-butadiene-styrene copolymer (ABS); b) from about 5 wt % to about 20 wt % of a polysiloxane-polycarbonate copolymer; c) from about 5 wt % to about 30 wt % high strength stainless steel fibers; and d) from about 0 wt % to about 30 wt % glass fibers; wherein the high strength stainless steel fibers have a single fiber strength of greater than or equal to about 20 cN and an elongation of greater than or equal to about 2%; and wherein the composition exhibits electromagnetic wave shielding performance at least about 60 dB when determined on a 1.2 mm thick sample.

### Articles

In various aspects, the disclosed electromagnetic wave shielding thermoplastic resin compositions with improved electromagnetic wave shielding of the present invention can be used in making articles. The disclosed electromagnetic wave shielding thermoplastic resin compositions can be formed and processed into useful shaped articles by a variety of means such as; injection molding, extrusion, rotational molding, compression molding, blow molding, sheet or film extrusion, profile extrusion, gas assist molding, structural foam molding and thermoforming. The electromagnetic wave shielding thermoplastic resin compositions described herein can also be made into film and sheet as well as components of laminate systems.

In one aspect, the invention relates to plastic articles comprising the disclosed electromagnetic wave shielding thermoplastic resin compositions. In a further aspect, the article is a part of a cellphone, a MP3 player, a computer, a laptop, a camera, a video recorder, an electronic tablet, a pager, a hand receiver, a video game, a calculator, a wireless car entry device, an automotive part, a filter housing, a luggage cart, an office chair, a kitchen appliance, an electrical housing, an electrical connector, a lighting fixture, a light emitting diode, an electrical part, or a telecommunications part. In a still further aspect, the article has a wall with a thickness of at greater than or equal to about 0.3 mm and less than or equal to about 2.0 mm. In a yet further aspect, the article has a wall with a thickness of at greater than or equal to about 0.3 mm and less than or equal to about 1.8 mm. In an even further aspect, the article has a wall with a thickness of at greater than or equal to about 0.3 mm and less than or equal to about 1.5 mm. In a still further aspect, the article has a wall with a thickness of at greater than or equal to about 0.8 mm and less than or equal to about 2.5 mm. In a yet further aspect, the article has a wall with a thickness of at greater than or equal to about 0.8 mm and less than or equal to about 1.8 mm. In an even further aspect, the article has a wall with a thickness of at greater than or equal to about 0.8 mm and less than or equal to about 1.5 mm.

In various aspects, the invention relates to electrical or electronic devices comprising the disclosed electromagnetic wave shielding thermoplastic resin compositions. In a further aspect, the electrical or electronic device is a cellphone, a MP3 player, a computer, a laptop, a camera, a video recorder, an electronic tablet, a pager, a hand receiver, a video game, a calculator, a wireless car entry device, an automotive part, a filter housing, a luggage cart, an office chair, a kitchen appliance, an electrical housing, an electrical connector, a lighting fixture, a light emitting diode, an electrical part, or a telecommunications part.

In various aspects, the disclosed compositions can be molded, foamed, or extruded into various structures or articles by known methods, such as injection molding, overmolding, extrusion, rotational molding, blow molding, and thermoforming. In particular, articles that benefit from EMI shielding are contemplated, such as electronic equipment, electronic housings, or electronic components. Non-limiting examples include computer housings, cell phone components, hand held electronic devices such as MP3 players, electronic tablets, pagers, camera housings, video recorders, video games, calculators, wireless car entry devices, automotive parts, filter housings, luggage carts, and office chairs, kitchen appliances, electrical housings, etc., e.g. a smart meter housing, and the like; electrical connectors, and components of lighting fixtures, ornaments, home appliances, Light Emitting Diodes (LEDs) and light panels, extruded film and sheet articles; electrical parts, such as relays; and telecommunications parts such as parts for base station terminals. The present disclosure further contemplates additional fabrication operations on said articles, such as, but not limited to, molding, in-mold decoration, baking in a paint oven, lamination, and/or thermoforming.

In a further aspect, the present invention pertains to articles selected from computer and business machine housings such as housings for monitors, handheld electronic device housings such as housings for cell phones and digital cameras, fixed electrical enclosures such as exit signs, humidifier housings and HVAC (heat ventilation and air conditioning) housings, electrical connectors, and components of lighting fixtures, ornaments, home appliances, roofs, greenhouses, sun rooms, swimming pool enclosures, and the like.

In various aspects, the present invention pertains to articles comprising electromagnetic wave shielding thermoplastic resin compositions. Formed articles include, for example, parts suitable for home and office appliances such as telephones, facsimiles, VTR, copying machines, televisions, microwave ovens, sound equipments, toiletry goods, laser disks, refrigerators and air conditioners. In a further aspect, the articles are used to housings for personal computers and mobile phones, and electric and parts for electronic appliances typified by keyboard supports which are members for supporting keyboards inside personal computers.

In various aspects, the molded article of the present invention has high EMI shielding, excellent thin-wall moldability, and high mechanical properties (strength, flexural modulus, impact strength, etc.). Therefore, the molded article is suitably used for housings or casings of an electronic or electrical appliance, an office automation appliance, a domestic electronic appliance, or a use in an automotive field, or component parts that require such properties and, in particular, housings or casings of portable electronic and electrical appliances and the like that require high levels of weight reductions. More specifically, the molded article is suitably used for housings or casings of large-size displays, notebook-size personal computers, portable telephones, PHS, PDA (portable information terminals such as electronic pocketbooks and the like), video cameras, digital still cameras, portable radio-cassette players and the like.

In a further aspect, the article of the present invention comprising the disclosed electromagnetic wave shielding thermoplastic resin compositions is selected from computer and business machine housings such as housings for monitors, handheld electronic device housings such as housings for cell phones and digital cameras, fixed electrical enclosures such as exit signs, humidifier housings and HVAC (heat ventilation and air conditioning) housings, electrical connectors, and components of lighting fixtures, ornaments, home appliances, roofs, greenhouses, sun rooms, swimming pool enclosures, and the like.

In one aspect, the invention pertains to a process for forming articles comprising a electromagnetic wave shielding thermoplastic resin composition comprising the steps of: feeding a blend of a polycarbonate and an acrylonitrile butadiene styrene polymer, high strength stainless steel fibers, and glass fibers into an in-line compounding machine; compounding blend of a polycarbonate and an acrylonitrile butadiene styrene polymer, high strength stainless steel fibers to form an electromagnetic wave shielding thermoplastic material; passing the electromagnetic wave shielding thermoplastic material to an injection plunger of the in-line compounding machine; and injecting the electromagnetic wave shielding thermoplastic material into a mold using either an injection molding process or an injection-compression molding process; wherein the article exhibits electromagnetic wave shielding performance of at least about 60 dB when determined on a 1.2 mm thick sample.

Without further elaboration, it is believed that one skilled in the art can, using the description herein, utilize the present invention. The following examples are included to provide addition guidance to those skilled in the art of practicing the claimed invention. The examples provided are merely representative of the work and contribute to the teaching of the present invention. Accordingly, these examples are not intended to limit the invention in any manner.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein may be different from the actual publication dates, which can require independent confirmation.

### Examples

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. Unless indicated otherwise, percentages referring to composition are in terms of wt %.

The materials shown in Table 1 were used to prepare the compositions described herein. Sample batches were prepared by pre-blending all constituents in a dry-blend and tumble mixing for about 4-6 minutes. All samples were prepared by melt extrusion by feeding the pre-blend into a Toshiba Twin screw extruder (37 mm), using a barrel temperature of about 240° C. to about 290° C., and a screw speed kept at about 300 rpm with the torque value maintained from about 70% to about 80%.

, and operated under standard processing conditions well known to one skilled in the art.

Melt volume rate (“MVR”) was determined per the test method of ASTM D1238 under the following test conditions: 270° C. melt temperature, a total load of 10 kg, a dwell time of 360 s, and an orifice diameter of 2.095 mm. Before testing, the samples were dried for three hours at 85° C. Data below are provided for MVR in cm³/10 min.

Specific gravity was determinated in accordance with ISO 1183.

The notched Izod impact (“NII”) test was carried out per ASTM D256 at 23° C. using a specimen of 3.2 mm thickness. Data below are provided for NII in J/m.

Heat deflection temperature was determined per ASTM D648 under a load of 1.82 MPa using a specimen 6.4 mm thickness. Data below are provided in ° C.

Spiral flow analysis of pellets was determined using a channel depth of 2 mm with a melt temperature of 280° C. and a mold temperature of 80° C.

EMI shielding was determined in accordance with ASTM D4935 on samples of the indicated wall thickness (see tables below).

Flexural properties (modulus and stress at yield) were determined in accordance with ASTM D790 at a loading speed of 1.27 mm/min on a 50 mm support span using a sample specimen of 3.18 mm×12.7 mm×127 mm. Test results were calculated as the average of test results of five test bars. The test involves a three point loading system utilizing center loading on a simply supported beam. Instron and Zwick are typical examples of manufacturers of instruments designed to perform this type of test. The flexural modulus is the ratio, within the elastic limit, of stress to corresponding strain and is expressed in Megapascals (MPa).

Tensile properties (modulus and stress at break) were determined in accordance with ASTM D638. Tensile modulus was determined using a test speed of 5 mm/min at 23° C. using a Type I tensile bar.

TABLE 1

| Identifier | Description | Source |
|---|---|---|
| PC1 | Blend of high flow and low flow BPA | SABIC Innovative |
| | polycarbonate resins made by an | Plastics (“SABIC |
| | interfacial process with an MVR at | I.P.”) |
| | 300° C./1.2 kg, of 13.0-14.0 g/10 min. | |
| PC/PDMS | A BPA polycarbonate-polysiloxane | SABIC I.P. |
| | copolymer comprising about 20% by | |
| | weight of a dimethylsiloxane, 80% by | |
| | weight BPA and endcapped with | |
| | paracumyl phenol.. The copolymer had | |
| | an absolute weight average molecular | |
| | weight of about 30,000 Da. | |
| ABS1 | Butadiene content of this material is | SABIC I.P. |
| | typically 17% and the rest contains | |
| | styrene and acrylonitrile (GE ABS | |
| | C29449). | |
| SSF | Standard strength stainless steel fiber | Hunan Huitong |
| | with 75 wt % stainless steel fiber with | Advanced Materials |
| | 15.75 wt % PSU, and 9.25 wt % | Co., Ltd. |
| | polyester as coat layers; single fiber | |
| | strength of 18-19 cN and single fiber | |
| | elongation of 1.2-1.5%; (Huitong | |
| | product no. HT-CH75-T20). | |
| HSSF | High strength stainless steel fiber with | Hunan Huitong |
| | 75 wt % stainless steel fiber with 15.75 | Advanced Materials |
| | wt % PSU, and 9.25 wt % polyester as | Co., Ltd. |
| | coat layers; single fiber strength of 22 | |
| | cN and single fiber elongation of | |
| | 2.2%. (Huitong product no. HT-CH75- | |
| | T20-HS). | |
| GF | Non-bonding glass fibers of 14 | OWENS-CORNING |
| | micrometers diameter and 3-11 | FIBERGLASS |
| | millimeters length (OWENS-CORING | |
| | product no. 415A-14C). | |
| BPA-DP | Bisphenol A bis(diphenyl phosphate); | Nagase Co. Ltd |
| | (Nagase product no. CR741). | |
| TSAN | SAN encapsulated PTFE- | SABIC I.P. |
| | intermediate resin. | |
| ZB | Zinc Borate | Borax Europe |
| | | Limited |
| PETS | Pentaerythritol tetrastearate | Faci Asia Pacific |
| | | PTE LTD |
| Mg(OH)2 | Magnesium Hydroxide (Kyowa | Kyowa Chemical |
| | product no. Kisuma 5A). | industry Co., Ltd |
| AO1 | Hindered phenol (Irganox 1076) | Ciba Specialty |
| | | Chemicals Ltd. |
| AO2 | Tris(2,4-ditert-butylphenyl) phosphite | Ciba Specialty |
| | (IRGAFOS 168). | Chemicals Ltd. |

In the examples below, the polycarbonate used was Lexan Bisphenol A polycarbonate (SABIC Innovative Plastics), ranging in molecular weight from 18,000 to 40,000 on an absolute PC molecular weight scale. It may be made by either the interfacial process, the melt process, or by an improved melt process. The ABS used was GE Advanced Materials Bulk ABS C29449 (a bulk ABS or “BABS”), which had a nominal 17 wt. % butadiene, with the remainder being styrene and acrylonitrile. The microstructure is phased inverted, with occluded SAN in a butadiene phase in a SAN matrix. The BABS can be manufactured using a plug flow reactor in series with a stirred, boiling reactor as described, for example, in U.S. Pat. No. 3,981,944 and U.S. Pat. No. 5,414,045. The glass fiber used in the examples described herein had a diameter of about 14 μm.

High strength stainless steel fiber used was Huitong's HT-CH75-T20-HS. Stainless steel fiber content of this material was about 75% and the weight balance was a coat layer comprising polysulfone and polyester. It is understood that “high strength SSF” means single fiber strength>20CN and single fiber elongation>2%, with electrical properties at similar level as in characteristic of standard stainless steel. In the examples described herein, the standard stainless steel (“SSF”) and high strength stainless steel (“HSSF”) had the properties shown in Table 2 below.

TABLE 2

| Steel Fiber | Single fiber strength, cN | Elongation (%) |
|---|---|---|
| General SSF | 18-19 | 1.2-1.5 |
| High strength SSF | 22 | 2.2 |

Representative polycarbonate formulations of the present invention and comparative samples are provided in Table 3, with the indicated amounts given as wt %.

TABLE 3

| # | Item | C1* | S1* | C2* | S2* |
|---|---|---|---|---|---|
| 1 | PC1 | 41.195 | 41.195 | 60.804 | 60.804 |
| 2 | PC/PDMS | 16 | 16 | 11.9 | 11.9 |
| 3 | ABS1 | 2.55 | 2.55 | 2.55 | 2.55 |
| 4 | SSF | 20 | — | 15 | — |
| 5 | HSSF | — | 20 | — | 15 |
| 6 | GF | 9.0 | 9.0 | — | — |
| 7 | BPA-DP | 9.0 | 9.0 | 8.5 | 8.5 |
| 8 | TSAN | 0.85 | 0.85 | 0.85 | 0.85 |
| 9 | ZB | 1.0 | 1.0 | — | — |
| 10 | PETS | 0.28 | 0.28 | 0.255 | 0.255 |
| 11 | Mg(OH)2 | 0.005 | 0.005 | 0.005 | 0.005 |
| 12 | AO1 | 0.06 | 0.06 | 0.068 | 0.068 |
| 13 | AO2 | 0.06 | 0.06 | 0.068 | 0.068 |
| TOTAL | | 100 | 100 | 100 | 100 |

The data shown in Table 4 show that EMI shielding was highly dependent upon material thickness for the comparator samples prepared using SSF. For example, even at high loading (20 wt % SSF), the EMI value is only around 40 dB at 1.2 mm thickness, whereas EMI of the same material is 60 dB at 3 mm thickness. In contrast, in an example of the disclosed compositions, the addition of high strength SSF, the EMI value for thin wall samples (i.e. less than 3 mm) was significantly improved compared to those of the control samples. Without wishing to be bound by a particular theory, the improvement in EMI shielding can result from the formation of hybrid conductive network with steady and perfect conductive path. The data for the two example samples indicate surprising and robust EMI shielding performance for thin wall parts.

TABLE 4

| | Stainless Steel | | EMI Shielding |
|---|---|---|---|
| Sample* | Fiber (amount)** | Thickness | (dB) |
| C1: Comparator 1 (SSF) | 15 wt % | 1.2 mm | 40.0 |
| | 15 wt % | 1.5 mm | 50.0 |
| | 15 wt % | 3.0 mm | 60.0 |
| S1: Example Sample 1 | 15 wt % | 1.2 mm | 53.8 |
| (HSSF) | 15 wt % | 1.5 mm | 59.6 |
| | 15 wt % | 3.0 mm | 61.5 |
| C2: Comparator 2 (SSF) | 20 wt % | 1.2 mm | 32 |
| | 20 wt % | 1.5 mm | 45 |
| | 20 wt % | 3.0 mm | 55 |
| S1: Example Sample 2 | 20 wt % | 1.2 mm | 47.3 |
| (HSSF) | 20 wt % | 1.5 mm | 53.4 |
| | 20 wt % | 3.0 mm | 61.2 |

*Samples were identical with respect to type and amount of polycarbonate/acrylonitrile-butadiene-styrene blend, glass fiber, and all other components. Comparator samples used the standard strength stainless steel fiber described above, and the example samples used the high strength stainless steel fiber described above.
**The wt % of the respective stainless steel fiber (i.e. standard strength stainless steel fiber for the comparator samples, and high strength stainless steel fiber for the example samples) as a wt % of the total weight of components in the formulation.

Moreover, the data in Table 5 show that the mechanical properties of the samples using H SSF are at similar level or even slightly higher compared to the controls samples using SSF.

TABLE 4

| Test | C1* | S1* | C2* | S2* |
|---|---|---|---|---|
| Density (g/cm³) | 1.44 | 1.43 | 1.33 | 1.31 |
| Notched Izod Impact (J/m) | 53.2 | 60.1 | 58.9 | 61.6 |
| Melt Volume Rate (cm³/10 min) | 14.5 | 12.6 | 41 | 12.8 |
| Flexural Modulus (MPa) | 5060 | 5470 | 3120 | 3310 |
| Flexural Strength at Yield (MPa) | 95.8 | 102 | 102 | 105 |
| Tensile Modulus (MPa) | 5482.6 | 5931.4 | 3356.4 | 3434.2 |
| Tensile Stress at Break (MPa) | 62.4 | 68.5 | 57.8 | 66.6 |
| Tensile Elongation at Break (%) | 2 | 1.8 | 2 | 2.8 |
| Spiral flow analysis (cm) | 35.8 | 34.1 | 38 | 35.3 |
| Heat deflection temperature (° C.) | 93.1 | 96.5 | 98.1 | 100 |

*“C1” is Comparator Sample 1 (see Table 3 and associated text); “S1” is Example Sample 1 (see Table 3 and associated text); “C2” is Comparator Sample 2 (see Table 3 and associated text); and “S2” is Example Sample 2 (see Table 3 and associated text).

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An electromagnetic wave shielding thermoplastic resin composition, comprising
a) a continuous thermoplastic polymer phase comprising from about 30 wt % to about 75 wt % of a blend of a polycarbonate and an acrylonitrile-butadiene-styrene copolymer (ABS);
b) a dispersed phase comprising a plurality stainless steel fibers and glass fibers dispersed within the continuous thermoplastic polymer phase;
i. wherein the high strength stainless steel fibers are present in an amount from about 5 wt % to about 30 wt %; wherein the high strength stainless steel fiber has a single fiber strength of greater than or equal to about 20 cN and an elongation of greater than or equal to about 2%;
ii. wherein the glass fibers are present in an amount from about 0 wt % to about 30 wt %;
wherein all weight percents are based on the total weight of the composition;
wherein the composition exhibits electromagnetic wave shielding performance at least about 10% greater when determined on a 1.5 mm thick sample compared to that of a reference composition consisting of substantially the same proportions of the blend of a polycarbonate and an acrylonitrile-butadiene-styrene copolymer (ABS), the same glass fiber, and a standard strength steel fiber instead of a high strength steel fiber; and
wherein the standard strength steel fiber has a single fiber strength of less than or equal to about 19 cN and an elongation of less than or equal to about 1.5%.

2. The composition of claim 1, wherein continuous thermoplastic polymer phase further comprises a polysiloxane-polycarbonate copolymer.

3. The composition of claim 2, wherein the polysiloxane-polycarbonate copolymer is present in an amount from about 5 wt % to about 20 wt %.

4. The composition of claim 2, wherein the polysiloxane-polycarbonate copolymer is present in an amount from about 10 wt % to about 17 wt %.

5. The composition of claim 2, wherein the polysiloxane-polycarbonate copolymer comprises a polysiloxane block of about 20 wt % of the polysiloxane-polycarbonate copolymer.

6. The composition of claim 1, wherein the polycarbonate comprises a blend of two or more polycarbonate polymers.

7. The composition of claim 6, wherein the polycarbonate blend comprises a low flow polycarbonate polymer and a high flow polycarbonate polymer.

8. The composition of claim 1, wherein the polycarbonate is present in an amount from about 30 wt % to about 60 wt %.

9. The composition of claim 1, wherein the polycarbonate has a weight average molecular weight from about 18,000 to about 40,000.

10. The composition of claim 1, wherein acrylonitrile-butadiene-styrene copolymer is present in an amount from about 2 wt % to about 15 wt %.

11. The composition of claim 1, wherein acrylonitrile-butadiene-styrene copolymer is present in an amount from about 2 wt % to about 5 wt %.

12. The composition of claim 1, wherein acrylonitrile-butadiene-styrene copolymer is a bulk polymerized ABS.

13. The composition of claim 1, wherein acrylonitrile-butadiene-styrene copolymer comprises from about 10 wt % to about 20 wt % polybutadiene.

14. The composition of claim 1, wherein acrylonitrile-butadiene-styrene copolymer comprises from about 12 wt % to about 18 wt % polybutadiene; wherein acrylonitrile-butadiene-styrene copolymer comprises from about 60 wt % to about 75 wt % styrene; and wherein acrylonitrile-butadiene-styrene copolymer comprises from about 10 wt % to about 20 wt % acrylonitrile.

15. The composition of claim 1, wherein the high strength stainless steel fiber further comprises a polymer coat layer.

16. The composition of claim 15, wherein the coat layer comprises a polysulfone, a polyester, or both a polysulfone and a polyester.

17. The composition of claim 15, wherein the coat layer comprises a polysulfone.

18. The composition of claim 15, wherein the high strength stainless steel fiber content is from about 70 wt % to about 80 wt %; and wherein the coat layer content is from about 10 wt % to about 20 wt %.

19. The composition of claim 1, wherein the high strength stainless steel fiber further comprises a polymeric sizing composition.

20. The composition of claim 19, wherein the polymeric sizing composition comprises a polyester.

21. The composition of claim 20, wherein the polyester comprises polybutylene terephthalate (PBT).

22. The composition of claim 19, wherein the polymeric sizing composition is present in an amount from about 5 wt % to about 15 wt %.

23. The composition of claims 15 and 19, wherein the high strength stainless steel fiber is present in an amount from about 70 wt % to about 85 wt %; wherein the polymeric sizing composition is present in an amount from about 5 wt % to about 15 wt %; and wherein the coating is present in an amount from about 10 wt % to about 20 wt %.

24. The composition of claim 1, wherein the high strength stainless steel fiber has a single fiber strength of greater than or equal to about 22 cN.

25. The composition of claim 1, wherein the high strength stainless steel fiber has an elongation of greater than or equal to about 2.2%.

26. The composition of claim 1, wherein the high strength stainless steel fiber has a single fiber strength of greater than or equal to about 22 cN and an elongation of greater than or equal to about 2.2%.

27. The composition of claim 1, wherein the electromagnetic wave shielding performance is at least about 52 db when measured according to ASTM D4935 using a 1.5 mm thick sample.

28. The composition of claim 1, wherein the electromagnetic wave shielding performance is at least about 45 db when measured according to ASTM D4935 using a 1.2 mm thick sample.

29. The composition of claim 1, wherein the composition further exhibits a Notched Izod Impact strength of greater than or equal to about 58 J/m when as measured according to ASTM D256.

30. The composition of claim 1, wherein the composition further exhibits a heat deflection temperature of greater than or equal to about 94° C. when measured according to ASTM D648.

31. The composition of claim 1, wherein the continuous thermoplastic polymer phase further comprises at least one polymer additive selected from a flame retardant, a colorant, a primary anti-oxidant, and a secondary anti-oxidant.

32. The composition of claim 31, wherein the continuous thermoplastic polymer phase further comprises one or more flame retardants.

33. The composition of claim 32, wherein at least one flame retardant is a phosphorus-containing flame retardant.

34. The composition of claim 33, wherein the phosphorus-containing flame retardant is bisphenol A bis(diphenyl phosphate).

35. The composition of claim 33, wherein the phosphorus-containing flame retardant is present in an amount from about 4 wt % to about 15 wt %.

36. The composition of claim 32, wherein at least one flame retardant is an inorganic flame retardant.

37. The composition of claim 36, wherein the inorganic flame retardant is zinc borate.

38. The composition of claim 36, wherein the inorganic flame retardant is present in an amount from about 0.1 wt % to about 5 wt %.

39. The composition of claim 31, wherein the primary anti-oxidant is selected from a hindered phenol and secondary aryl amine, or a combination thereof.

40. The composition of claim 39, wherein the hindered phenol comprises octadecyl-3-(3,5-di-t-butyl-4-hydroxyphenyl)-propionate.

41. The composition of claim 31, wherein the primary anti-oxidant is present in an amount from about 0.01 wt % to about 0.20 wt %.

42. The composition of claim 31, wherein the secondary anti-oxidant is selected from an organophosphate and thioester, or a combination thereof.

43. The composition of claim 31, wherein the secondary anti-oxidant comprises tris(2,4-di-tert-butylphenyl) phosphite.

44. The composition of claim 31, wherein the secondary anti-oxidant is present in an amount from about 0.01 wt % to about 0.20 wt %.

45. The composition of claim 1, wherein the continuous thermoplastic polymer phase further comprises an anti-drip agent.

46. The composition of claim 45, wherein the anti-drip agent is present in an amount from about 0.1 wt % to about 5 wt %.

47. The composition of claim 45, wherein the anti-drip agent is styrene-acrylonitrile copolymer encapsulated PTFE (TSAN).

48. An electromagnetic wave shielding thermoplastic resin composition, comprising
a) a continuous thermoplastic polymer phase comprising from about 30 wt % to about 75 wt % of a blend of a polycarbonate and an acrylonitrile-butadiene-styrene copolymer (ABS);
b) a dispersed phase comprising a plurality stainless steel fibers and glass fibers dispersed within the continuous thermoplastic polymer phase;
i) wherein the high strength stainless steel fibers are present in an amount of about 15 wt %; wherein the high strength stainless steel fiber has a single fiber strength of greater than or equal to about 20 cN and an elongation of greater than or equal to about 2%;
ii) wherein the glass fibers are present in an amount from about 0 wt % to about 30 wt %;
wherein the composition exhibits electromagnetic wave shielding performance of at least about 52 dB when determined on a 1.5 mm thick sample.

49. An electromagnetic wave shielding thermoplastic resin composition, comprising
a) a continuous thermoplastic polymer phase comprising
i) from about 30 wt % to about 75 wt % of a blend of a polycarbonate and an acrylonitrile-butadiene-styrene copolymer (ABS);
ii) from about 5 wt % to about 20 wt % of a polysiloxane-polycarbonate copolymer;
b) a dispersed phase comprising a plurality stainless steel fibers and glass fibers dispersed within the continuous thermoplastic polymer phase;
i) wherein the high strength stainless steel fibers are present in an amount of about 15 wt %; wherein the high strength stainless steel fiber has a single fiber strength of greater than or equal to about 20 cN and an elongation of greater than or equal to about 2%;
ii) wherein the glass fibers are present in an amount from about 0 wt % to about 30 wt %;
wherein the composition exhibits electromagnetic wave shielding performance of at least about 52 dB when determined on a 1.5 mm thick sample.

50. A plastic article comprising the electromagnetic wave shielding thermoplastic resin composition of any of claims 1-49.

51. The article of claim 50, wherein the article is a part of a cellphone, a MP3 player, a computer, a laptop, a camera, a video recorder, an electronic tablet, a pager, a hand receiver, a video game, a calculator, a wireless car entry device, an automotive part, a filter housing, a luggage cart, an office chair, a kitchen appliance, an electrical housing, an electrical connector, a lighting fixture, a light emitting diode, an electrical part, or a telecommunications part.

52. The article of claim 50, wherein the article has a wall with a thickness of at greater than or equal to about 0.3 mm and less than or equal to about 2.0 mm.

53. The article of claim 50, wherein the article has a wall with a thickness of at greater than or equal to about 0.8 mm and less than or equal to about 1.5 mm.

54. An electrical or electronic device comprising the electromagnetic wave shielding thermoplastic resin composition of any of claims 1-49.

55. The electrical or electronic device of claim 54, wherein the electrical or electronic device is a cellphone, a MP3 player, a computer, a laptop, a camera, a video recorder, an electronic tablet, a pager, a hand receiver, a video game, a calculator, a wireless car entry device, an automotive part, a filter housing, a luggage cart, an office chair, a kitchen appliance, an electrical housing, an electrical connector, a lighting fixture, a light emitting diode, an electrical part, or a telecommunications part.

56. A method of preparing a composition, comprising: blending
a) from about 30 wt % to about 75 wt % of a blend of a polycarbonate and an acrylonitrile-butadiene-styrene copolymer (ABS);
b) from about 5 wt % to about 20 wt % of a polysiloxane-polycarbonate copolymer;
c) from about 5 wt % to about 30 wt % high strength stainless steel fibers; and
d) from about 0 wt % to about 30 wt % glass fibers;
wherein the high strength stainless steel fibers have a single fiber strength of greater than or equal to about 20 cN and an elongation of greater than or equal to about 2%; and wherein the composition exhibits electromagnetic wave shielding performance at least about 60 dB when determined on a 1.2 mm thick sample.
